(19) United States
(12) Patent Application Publication
(10) Pub. No.: US 2015/0166583 A1
(43) Pub. Date: Jun. 18, 2015

(54) STABILIZED HYDROCYANATION LIGAND COMPOSITION

(71) Applicant: INVISTA NORTH AMERICA S.A.R.L., Wilmington, DE (US)

(72) Inventors: Sudhir Aki, Katy, TX (US); Thomas E. Vos, Beaumont, TX (US)

(73) Assignee: INVISTA NORTH AMERICA S.A R.L., Wilmington, DE (US)

(21) Appl. No.: 14/404,083

(22) PCT Filed: May 24, 2013
(86) PCT No.: PCT/US13/42651

§ 371 Date: Nov. 26, 2014

Related U.S. Application Data
(60) Provisional application No. 61/654,569, filed on Jun. 1, 2012.
(60) Provisional application No. 61/660,047, filed on Jun. 15, 2012.

(51) Int. Cl. C07F 9/02; B65D 25/14; B01J 31/22; C07F 9/145; C07F 9/6574

(52) U.S. Cl. CPC C07F 9/025; C07F 9/145; C07F 9/65744; B01J 31/22; B65D 25/14; B01J 2531/847; B01J 2231/322

(57) ABSTRACT

A method of stabilizing a phosphorus-based ligand or a ligand blend comprising a plurality of phosphorus-based ligands, wherein the ligand or ligand blend comprises one or more of (i) a bidentate biphosphite ligand of formula (III), (R¹²—X¹²) (R¹³—X¹³)P—X¹⁴—Y—X²⁴—P (X²²—R²²) (X²³—R²³) (ii) a tridentate triphosphite ligand of formula (IIIA) (R¹²—X¹²) (R¹³—X¹³)P—X¹⁴—Y—X³²—P(X³⁴—R³⁴)—(X³³—Y²—R²⁴—P(X²³—R²³)—(X²²—R²²) or (iii) a monodentate phosphite ligand of formula (IV) P(X¹—R¹)(X²—R²)(X³—R³) where each X is oxygen or a bond and each Y is optionally substituted C6-C20 arylene; the process comprising forming a mixture of the ligand or the ligand blend with a liquid which partially or fully solubilizes the ligand or ligand blend, the liquid consisting essentially of one or more of: (a) a solvent system that does not contain peroxidizable species; or, (b) a solvent system that is substantially free of a dissolved metal.

### CROSS-REFERENCE TO RELATED APPLICATIONS

This application claims benefit of priority from U.S. Provisional Application No. 61/654,569 filed Jun. 1, 2012 and U.S. Provisional Application No. 61/660,047 filed Jun. 15, 2012. These applications hereby incorporate by reference these provisional applications in their entirety.

### FIELD OF THE INVENTION

The invention field relates to hydrocyanation catalysts, their stabilization, storage and transport. The invention can provide methods and compositions for enhancing the storage stability of phosphorus-based ligands, resulting in a higher catalytic activity after formation of a metal complex for use in hydrocyanation reactions.

### BACKGROUND OF THE INVENTION

U.S. Pat. No. 6,169,198 describes the process of hydrocyanation (reaction with HCN) of butadiene to prepare adiponitrile, and explains that the process can generally be divided into three steps. First, mononitriles such as 3-pentenenitrile (3-PN) are formed by the reaction of HCN with BD, along with other nitriles, including isomers which must be isomerized in subsequent steps to achieve the desired straight chain ADN as a final product. Second is the isomerization of species such as 2-methyl-3-butenenitrile (2M3BN). Third is a second hydrocyanation of the pentenenitriles to yield the desired ADN.

U.S. Pat. No. 5,981,722 describes and exemplifies a new class of catalysts for such transformations by the use of diphosphite nickel complexes for the hydrocyanation and isomerizations. This class of catalysts is characterized by greater catalytic activity and resistance to HCN-derived degradation reactions.

U.S. Pat. No. 7,470,805 describes a process of hydrocyanation of diolefins in the presence of a catalytic system comprising a transition metal and mono- and pluri-dentate organophosphorus ligands. According to this, the use of a mixture of two ligands, monodentate and pluridentate (bidentate and/or tridentate), enables the pluridentate ligand to be preserved in the reaction milieu.

Monodentate and bidentate phosphorus-based ligands, depicted as formulae (7) and (8), and (3), respectively, as the structures are termed in U.S. Pat. No. 7,629,484, can be used in preparation of a transition metal-organophosphorus catalyst for reactions such as hydrocyanation.

### Monodentate Ligand Examples of U.S. Pat. No. 7,629,484

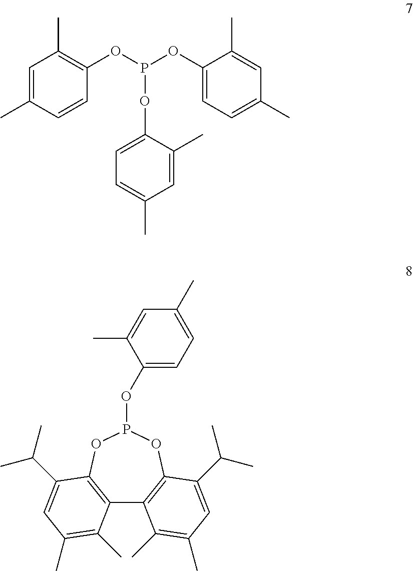

### Bidentate Ligand Example of U.S. Pat. No. 7,629,484

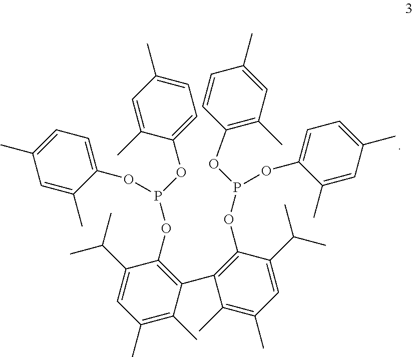

U.S. Pat. No. 7,659,422 describes a hydrocyanation process to produce ADN from BD with control of i) the overall feed molar ratio of 2-pentenenitriles to all unsaturated nitriles and ii) the overall feed molar ratio of HCN to all unsaturated nitriles. An example is given as a reaction mixture comprising a Lewis acid promoter (FeCl₂) and bidentate Ligand B, which is as depicted as identical to Compound (3) above.

U.S. Pat. No. 7,977,502 describes an integrated, continuous process for the production of 3-PN, the refining of 3-PN and the refining of 2M3BN by a process comprising contacting a feed stream in a reaction zone, maintaining residence time to convert about 95% or more of the HCN, distilling to create various streams.

U.S. Published Patent Application No. 2011/0196168 describes nickel-containing solids comprising nickel metal derived from basic nickel carbonates (BNCs) which are highly reactive with both monodentate and Bidentate phosphorus-containing ligands in forming nickel metal complexes, which can be for producing pentenenitriles and dinitriles by hydrocyanation.

### SUMMARY OF THE INVENTION

The invention is directed to processes for providing enhanced stability for hydrocyanation catalysts, such as by the use of containers that do not leach metals that catalyze the oxidation of ligands used for hydrocyanation catalysts, by use of solvents which do not readily form or tolerate peroxides, and by combinations of techniques whereby the catalysts can be transported and stored more effectively and with greater preservation of catalytic activity when used in a hydrocyanation process.

The invention can provide a method of stabilizing a phosphorus-based ligand or a ligand blend comprising a plurality of phosphorus-based ligands, the ligand or ligand blend being for formation of a metal-ligand complex for catalysis of a hydrocyanation reaction, wherein the ligand or ligand blend comprises one or more of:

a bidentate phosphorus-based ligand of formula (III)

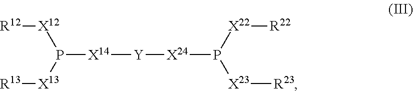

or, a tridentate phosphorus-based ligand of formula (IIIA)

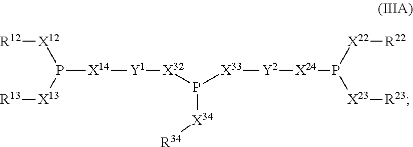

wherein for the ligand of formula (III), X¹², X¹³, X¹⁴, X²², X²³, and X²⁴, each independently is oxygen or a bond, provided that at least one of X¹², X¹³, X¹⁴, X²², X²³, or X²⁴ is oxygen, and for the ligand of formula (IIIA), X¹², X¹³, X¹⁴, X²², X²³, X²⁴, X³², X³³, and X³⁴, each independently is oxygen or a bond, provided that at least one of X¹², X¹³, X¹⁴, X²², X²³, X²⁴, X³², X³³, or X³⁴ is oxygen;

for the ligand of formula (III), R¹², R¹³, R²², and R²³, and for the ligand of formula (IIIA), R¹², R¹³, R²², R²³, and R³⁴, each independently is (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹², R¹³, R²², R²³, or R³⁴, each ring thereof is unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cyclo alkyl(C1-C10)alkoxy, (C3-C10)cycloalkoxy(C1-C10)alkoxy, (C6-C20)aryl, and (C6-C20)aryl(C1-C10)alkyl; or, one or more of pairs R¹² and R¹³ or R²² and R²³ are mutually directly bonded, such that the R¹²X¹² and R¹³X¹³ groups, or the R²²X²² and R²³X²³ groups, or both, together with the respective phosphorus atom to which each pair of groups is bonded, forms a respective ring;

for the ligand of formula (III) the group Y, and for the ligand of formula (IIIA), the groups Y¹ and Y² independently, is an (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl;

or, a monodentate phosphorus-based ligand of formula (IV)

P(X¹R¹)(X²R²)(X³R³) (IV)

wherein X¹, X² and X³ are each independently oxygen or a single bond, provided that at least one of X¹, X², or X³ is an oxygen; and R¹, R² and R³ is each independently (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹, R², or R³ each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, any two of R¹, R², or R³ are directly bonded to each other such that any pair of R¹X¹, R²X², and R³X³ groups, together with the phosphorus atom to which they are bonded, forms a ring;

the process comprising forming a mixture of the ligand or the ligand blend with a liquid which partially or fully solubilizes the ligand or ligand blend, the liquid consisting essentially of one or more of:

(a) a solvent system that does not contain peroxidizable species; or,

(b) a solvent system that is substantially free of a dissolved metal;

wherein the process optionally further comprises utilizing a container to contain the mixture of the ligand or ligand blend and the liquid, the container having an inner surface in contact with the liquid that does not leach a metal into the liquid.

The invention can also provide a stabilized composition comprising a phosphorus-based ligand or a ligand blend comprising a plurality of phosphorus-based ligands, the ligand or ligand blend being for formation of a metal-ligand complex for catalysis of a hydrocyanation reaction, wherein the ligand or ligand blend comprises one or more of:

a bidentate phosphorus-based ligand of formula (III)

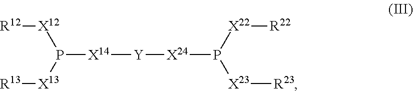

or, a tridentate phosphorus-based ligand of formula (IIIA)

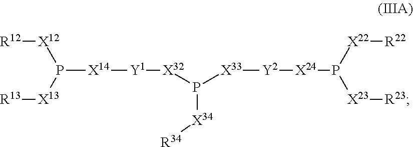

wherein for the ligand of formula (III), X¹², X¹³, X¹⁴, X²², X²³, and X²⁴, each independently is oxygen or a bond, provided that at least one of X¹², X¹³, X¹⁴, X²², X²³, or X²⁴ is oxygen, and for the ligand of formula (IIIA), X¹², X¹³, X¹⁴, X²², X²³, X²⁴, X³², X³³, and X³⁴, each independently is oxygen or a bond, provided that at least one of X¹², X¹³, X¹⁴, X²², X²³, X²⁴, X³², X³³, or X³⁴ is oxygen;

for the ligand of formula (III), R¹², R¹³, R²², and R²³, and for the ligand of formula (IIIA), R¹², R¹³, R²², R²³, and R³⁴, each independently is (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹², R¹³, R²², R²³, or R³⁴, each ring thereof is unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, one or more of pairs R¹² and R¹³ or R²² and R²³ are mutually directly bonded, such that the R¹²X¹² and R¹³X¹³ groups, or the R²²X²² and R²³X²³ groups, or both, together with the respective phosphorus atom to which each pair of groups is bonded, forms a respective ring;

for the ligand of formula (III) the group Y, and for the ligand of formula (IIIA), the groups Y¹ and Y² independently, is an (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl;

or, a monodentate phosphorus-based ligand of formula (IV)

P(X¹R¹)(X²R²)(X³R³) (IV)

wherein X^{l}, X² and X³ are each independently oxygen or a single bond, provided that at least one of X¹, X², or X³ is an oxygen; and R¹, R² and R³ is each independently (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹, R², or R³ each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, any two of R¹, R², or R³ are directly bonded to each other such that any pair of R¹X¹, R²X², and R³X³ groups, together with the phosphorus atom to which they are bonded, forms a ring;

and, a liquid which partially or fully solubilizes the ligand or ligand blend, the liquid consisting essentially of one or more of:

(a) a solvent system that does not contain peroxidizable species; or,

(b) a solvent system that is substantially free of a dissolved metal.

The stabilized composition can also be provided with further stability for storage or transport by containment in a storage container, the container having an inner surface in contact with the liquid that does not leach a metal such as nickel into the liquid containing the ligand or ligand blend.

Accordingly, the invention can solve the technical problem of stabilizing phosphorus-based ligands during storage and transport, by providing methods and compositions that increase the stability of ligands, particularly of bidentate and tridentate phosphorus-based ligands. Such ligands, when used in the formation of metal complexes with metals such as nickel, which are useful for catalysis of hydrocyanation reactions, are preserved against degradation, such that the resulting catalysts can have a higher degree of catalytic activity for hydrocyanation, e.g., the hydrocyanation reactions of butadiene to yield adiponitrile.

### DETAILED DESCRIPTION OF THE INVENTION

As used in the specification and the appended claims, the singular forms “a,” “an” and “the” include plural referents unless the context clearly dictates otherwise.

The term “about” as used herein, when referring to a numerical value or range, allows for a degree of variability in the value or range, for example, within 10%, or within 5% of a stated value or of a stated limit of a range.

As used herein, “substantially free” refers to a majority of, or mostly, as in at least about 97%, 98%, 99%, 99.5%, 99.9%, 99.99%, 99.999%, 99.9999%, or at least about 99.99999% free. For example, “substantially free” can mean that less than 1000 ppm, or less than 500 ppm, or less than 400 ppm, or less than 200 ppm, or less than 100 ppm, or less than 50 ppm, or less than 25 ppm, or less than 10 ppm, or less than 5 ppm, or less than 1 ppm of an undesirable material, impurity or contaminant is present.

All percent compositions are given as weight-percentages, unless otherwise stated.

Aspects of the present disclosure employ, unless otherwise indicated, techniques of chemistry, and the like, which are within the skill of the art. Such techniques are explained fully in the literature. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

Phrases such as “under conditions suitable to provide” or “under conditions sufficient to yield” or the like, in the context of methods of synthesis, as used herein refers to reaction conditions, such as time, temperature, solvent, reactant concentrations, and the like, that are within ordinary skill for an experimenter to vary, that provide a useful quantity or yield of a reaction product. It is not necessary that the desired reaction product be the only reaction product or that the starting materials be entirely consumed, provided the desired reaction product can be isolated or otherwise further used.

By “chemically feasible” is meant a bonding arrangement or a compound where the generally understood rules of organic structure are not violated; for example a structure within a definition of a claim that would contain in certain situations a pentavalent carbon atom that would not exist in nature would be understood to not be within the claim. The structures disclosed herein are intended to include only “chemically feasible” structures, and any recited structures that are not chemically feasible, for example in a structure shown with variable atoms or groups, are not intended to be disclosed or claimed herein.

When a substituent is specified to be an atom or atoms of specified identity, “or a bond”, a configuration is referred to when the substituent is “a bond” that the groups that are immediately adjacent to the specified substituent are directly connected to each other in a chemically feasible bonding configuration.

All chiral, diastereomeric, racemic forms of a structure are intended, unless a particular stereochemistry or isomeric form is specifically indicated. In several instances though an individual stereoisomer is described among specifically claimed compounds, the stereochemical designation does not imply that alternate isomeric forms are less preferred, undesired, or not claimed. Compounds used in the present invention can include enriched or resolved optical isomers at any or all asymmetric atoms as are apparent from the depictions, at any degree of enrichment. Both racemic and diastereomeric mixtures, as well as the individual optical isomers can be isolated or synthesized so as to be substantially free of their enantiomeric or diastereomeric partners, and these are all within the scope of the invention.

As used herein, the terms “stable compound” and “stable structure” are meant to indicate a compound that is sufficiently robust to survive isolation to a useful degree of purity from a reaction mixture, and formulation into an efficacious therapeutic agent. Only stable compounds are contemplated herein.

An “organic radical” or “organic group”, as the term is used herein, refers to a portion or fragment or moiety, capable of bonding to another atom, wherein the group is carbon-based. By “carbon-based” is meant that at least a portion of the group comprises at least one carbon atom, which can be covalently bonded to other atoms capable of covalent bonding such as hydrogen, nitrogen, oxygen, halogen, sulfur, phosphorus, and the like, as is well known in the art.

When a group, e.g., an “alkyl” group or an “aryl” group, is referred to without any limitation on the number of atoms in the group, it is understood that the claim is definite and limited with respect the size of the alkyl group, both by definition; i.e., the size (the number of carbon atoms) possessed by a group such as an alkyl group is a finite number, bounded by the understanding of the person of ordinary skill as to the size of the group as being reasonable for a molecular entity; and by functionality, i.e., the size of the group such as the alkyl group is bounded by the functional properties the group bestows on a molecule containing the group such as solubility in aqueous or organic liquid media. Therefore, a claim reciting an “alkyl” or other chemical group or moiety is definite and bounded.

Standard abbreviations for chemical groups such as are well known in the art can be used herein, and are within ordinary knowledge; e.g., Me=methyl, Et=ethyl, i-Pr=isopropyl, Bu=butyl, t-Bu=tert-butyl, Ph=phenyl, Bn=benzyl, Ac=acetyl, Bz=benzoyl, and the like.

In general, “substituted” refers to an organic group as defined herein in which one or more bonds to a hydrogen atom contained therein are replaced by one or more bonds to a non-hydrogen atom such as, but not limited to, a halogen (i.e., F, C1, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR′, OC(O)N(R′)₂, CN, NO, NO₂, ONO₂, azido, CF₃, OCF₃, R′, O (oxo), S (thiono), methylenedioxy, ethylenedioxy, N(R′)₂, SR′, SOR′, SO₂R′, SO₂N(R′)₂, SO₃R′, C(O)R′, C(O)C(O)R′, C(O)CH₂C(O)R′, C(S)R′, C(O)OR′, OC(O)R′, C(O)N(R)₂, OC(O)N(R′)₂, C(S)N(R′)₂, (CH₂)₀₋₂N(R)C(O)R′, (CH₂)₀₋₂N(R′)N(R′)₂, N(R′)N(R′)C(O)R′, N(R′)N(R′)C(O)OR′, N(R′)N(R′)CON(R′)₂, N(R′)SO₂R′, N(R′)SO₂N(R′)₂, N(R′)C(O)OR′, N(R′)C(O)R′, N(R′)C(S)R′, N(R)C(O)N(R)₂, N(R′)C(S)N(R′)₂, N(COR′)COR′, N(OR′)R′, C(═NH)N(R′)₂, C(O)N(OR′)R′, or C(═NOR′)R′ wherein R′ can be hydrogen or a carbon-based moiety, and wherein the carbon-based moiety can itself be further substituted; for example, wherein R′ can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R′ can be independently mono- or multi-substituted with J; or wherein two R′ groups bonded to a nitrogen atom or to adjacent nitrogen atoms can together with the nitrogen atom or atoms form a heterocyclyl, which can be mono- or independently multi-substituted with J.

Substituent groups J can independently be halo, nitro, cyano, OR, NR₂, or R, or is C(O)OR, C(O)NR₂, OC(O)OR, OC(O)NR₂, N(R)C(O)OR, N(R)C(O)NR₂ or thio/thiono analogs thereof. By “thio/thiono analogs thereof”, with respect to a group containing an O, is meant that any or all O atoms in the group can be replaced by an S atom; e.g., for group C(O)OR, a “thio/thiono analog thereof” includes C(S)OR, C(O)SR, and C(S)SR; e.g., for group OC(O)NR₂, a “thio/thiono analog thereof” includes SC(O)NR₂, OC(S)NR₂, and SC(S)NR₂; and so forth. When a substituent is monovalent, such as, for example, F or Cl, it is bonded to the atom it is substituting by a single bond. When a substituent is more than monovalent, such as O, which is divalent, it can be bonded to the atom it is substituting by more than one bond, i.e., a divalent substituent is bonded by a double bond; for example, a C substituted with O forms a carbonyl group, C═O, which can also be written as “CO”, “C(O)”, or “C(═O)”, wherein the C and the 0 are double bonded. When a carbon atom is substituted with a double-bonded oxygen (═O) group, the oxygen substituent is termed an “oxo” group. When a divalent substituent such as NR is double-bonded to a carbon atom, the resulting C(═NR) group is termed an “imino” group. When a divalent substituent such as S is double-bonded to a carbon atom, the results C(═S) group is termed a “thiocarbonyl” or “thiono” group.

Alternatively, a divalent substituent such as O or S can be connected by two single bonds to two different carbon atoms. For example, O, a divalent substituent, can be bonded to each of two adjacent carbon atoms to provide an epoxide group, or the O can form a bridging ether group, termed an “oxy” group, between adjacent or non-adjacent carbon atoms, for example bridging the 1,4-carbons of a cyclohexyl group to form a [2.2.1]-oxabicyclo system. Further, any substituent can be bonded to a carbon or other atom by a linker, such as (CH₂)ₙ or (CR′₂)ₙ wherein n is 1, 2, 3, or more, and each R′ is independently selected.

Alkyl groups include straight chain and branched alkyl groups and cycloalkyl groups having from 1 to about 20 carbon atoms, and typically from 1 to 12 carbons or, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed above, for example, amino, hydroxy, cyano, carboxy, nitro, thio, alkoxy, and halogen groups.

Cycloalkyl groups are cyclic alkyl groups such as, but not limited to, cyclopropyl, cyclobutyl, cyclopentyl, cyclohexyl, cycloheptyl, and cyclooctyl groups. The cycloalkyl group can have 3 to about 8-12 ring members, or, the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbomyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

(Cycloalkyl)alkyl groups, also denoted cycloalkylalkyl, are alkyl groups as defined above in which a hydrogen or carbon bond of the alkyl group is replaced with a bond to a cycloalkyl group as defined above.

The term “alkoxy” refers to an, oxygen atom connected to an alkyl group, including a cycloalkyl group, as are defined above. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include one to about 12-20 carbon atoms bonded to the oxygen atom, and can further include double or triple bonds, and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structures are substituted therewith.

Aryl groups are cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. Aryl groups can contain about 6 to about 14 carbons in the ring portions of the groups. Aryl groups can be unsubstituted or substituted, as defined above. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed above. Aryl groups can also bear fused rings, such as fused cycloalkyl rings, within the meaning herein. For example, a tetrahydronaphthyl ring is an example of an aryl group within the meaning herein. Accordingly, an aryl ring includes, for example, a partially hydrogenated system, which can be unsubstituted or substituted, and includes one or more aryl rings substituted with groups such as alkyl, alkoxyl, cycloalkyl, cycloalkoxyl, cycloalkylalkyl, cycloalkoxyalkyl, and the like, and also fused with, e.g., a cycloalkyl ring.

Organophosphorus compounds include molecular entities wherein one or more phosphorus atoms is present, and one or more organic radicals or moieties is also present. An organophosphorus compound can further include other elements such as oxygen, halogens, hydrogen, nitrogen, and the like. Some terms in common usage for various classes of organophosphorus compounds, wherein P is a phosphorus atom and R indicates an organic moiety that is bonded via a carbon-phosphorus bond to the phosphorus atom, include “phosphine” (PR₃), “phosphine oxide” (P(O)R₃), “phosphinite” (P(OR)R₂), “phosphonite” (P(OR)₂R), “phosphinate” (ROP(O)R₂), “phosphite” (P(OR)₃), “phosphonate” (RP(O)(OR)₂), and “phosphate” (P(O)(OR)₃).

A “phosphorus-based ligand” as the term is used herein refers to a ligand containing at least one phosphorus atom, that is suitable for formation of a complex with a transition metal such as nickel, wherein the complex can possess catalytic activity for an organic reaction such as a hydrocyanation reaction of an olefin, such as the hydrocyanation of butadiene to yield pentenenitrile, or the hydrocyanation of pentenenitrile to yield adiponitrile. The term “phosphorus-based” refers to an organic compound that contains at least one phosphorus atom, whether or not it has catalytic activity.

A “monodentate” phosphorus-based ligand contains a single phosphorus atom per molecule, which can complex a metal atom such as nickel. A “bidentate” phosphorus-based ligand contains two phosphorus atoms per molecule, both of which can complex a single metal atom, such as a nickel atom. A “tridentate” phosphorus-based ligand contains three phosphorus atoms per molecule, all three of which can complex a single metal atom, such as a nickel atom.

The term “adding to said reaction mixture before or during said hydrocyanation therewith a stabilizing amount of one or more monodentate phosphorus-based ligand of formula (IV)” as used herein refers to either deliberate addition of the one of more monodentate ligands of formula (IV), or not removing the one of more monodentate ligands of formula (IV) present in a synthetic reaction product of a reaction synthesizing the bidentate ligand of formula (III) or the tridentate ligand of formula (IIIA) or both, when the bidentate and/or tridentate ligand is prepared and used without removal of the monodentate ligand present as a process impurity.

If a value of a variable that is necessarily an integer, e.g., the number of carbon atoms in an alkyl group or the number of substituents on a ring, is described as a range, e.g., 0-4, what is meant is that the value can be any integer between 0 and 4 inclusive, i.e., 0, 1, 2, 3, or 4.

The compound or set of compounds, such as are used in the inventive methods, can be any one of any of the combinations and/or sub-combinations of the elements as described herein.

A compound as shown in any of the Examples, or among the exemplary compounds, is provided.

Provisos can apply to any of the disclosed categories wherein any one or more of the other above disclosed categories or species can be excluded from such categories.

### Hydrocyanation of Butadiene

The hydrocyanation of BD to yield ADN directly or indirectly through isomerization and/or additional hydrocyanation of intermediates with modern phosphorus-containing catalysts set forth below is well known in the art as evidenced by U.S. Pat. No. 7,977,502; and U.S. Pat. No. 7,659,422 and U.S. Published Applications 2009/0182164 and 2010/0267990. Various modifications can be used alone or in combination to achieve the desired efficiency with the selected components of the reaction. Thus, separation steps, temperatures, refining, distillation, isomerization zones, pressures, elimination of constituents along the pathway, column sizes and configurations, stream velocities, recycling, and other process variables can be adjusted to modify the overall ADN production as required.

The catalyst composition can be dissolved in a solvent that is non-reactive toward, and miscible with, the hydrocyanation reaction mixture. Suitable solvents include, for example, aliphatic and aromatic hydrocarbons with 1 to 10 carbon atoms, and nitrile solvents such as acetonitrile. Alternatively, 3PN, a mixture of isomeric pentenenitriles, a mixture of isomeric methylbutenenitriles, a mixture of isomeric pentenenitriles and isomeric methylbutenenitriles, or the reaction product from a previous reaction campaign, can be used to dissolve to the catalyst composition.

The HCN-containing feed, the BD-containing feed, and the catalyst composition are contacted in a reaction zone which can be contained in any suitable equipment known to one skilled in the art. One or more pieces of conventional equipment can be used to provide the reaction zone, for example continuous stirred-tank reactors, loop-type bubble column reactors, gas circulation reactors, bubble column reactors, tubular reactors, or combinations thereof, optionally with apparatus for removing at least a portion of the heat of reaction.

The reaction temperature is typically maintained within the range of about 80° C. to about 140° C., for example within the range of about 100° C. to about 130° C. Generally, the reaction pressure should be sufficient to maintain the reagents in the liquid state, with such pressure at least, in part, a function of the amount of unreacted BD present in the reaction mixture.

Though the invention is not limited by an upper limit of pressure, for practical purposes the pressure generally ranges from about 15 psia to about 300 psia (about 103 kPa to about 30 2068 kPa).

HCN, substantially free of carbon monoxide, oxygen, ammonia, and water can be introduced to the reaction as a vapor, liquid, or mixtures thereof. As an alternative, cyanohydrins can be used as the source of HCN. See, for example, U.S. Pat. No. 3,655,723.

The molar ratio of the HCN in the feed to the BD in the feed is in the range of about 0.90:1.00 to about 1.04:1.00, for example in the range of about 0.92:1.00 to about 0.98:1.00.

This range of molar ratios can be advantageous over those 40 with a significantly larger excess of BD to HCN in that there can be less unreacted BD to recover and recycle to the process, and yield losses to 2-methylglutaronitrile (MGN) and to BD dimers, oligomers, and related species can be reduced. The molar ratio of the zero-valent nickel in the feed to the BD in the feed is in the range of about 0.00005:1.00 to about 0.0050:1.00, for example in the range about 0.0001:1.00 to about 0.0010:1.00.

The residence time in the reaction zone (for example, the time necessary for the combined feeds to displace one reactor so volume in a continuous-stirred-tank-reactor (CSTR) is typically determined by the desire to maintain the 2M3BN concentration below about 15 weight percent of the total mass of the reaction mixture, for example at or below about 10 weight percent of the total mass of the reaction mixture, and is also related to the catalyst concentration and reaction temperature. Generally residence times will be in the range of about 0.5 to about 15 hours, for example in the range of about 1 to about 10 hours.

Water can be present in commercially available BD. Water can be undesirable in hydrocyanation processes as it can react with the phosphorus-containing ligand to produce hydrolysis products which are less active or inactive for the desired hydrocyanation and isomerization reactions. The ligand hydrolysis products can also promote undesired side reactions.

Prior to its use in hydrocyanation, BD can be purified to remove impurities such as TBC and water. TBC can be removed from BD by a variety of techniques, for example by distillation or by passing the liquid BD over an absorbent bed such as alumina. Distillation can also be used to remove other impurities, for example 4-vinyl-1-cyclohexene, from BD. Water can be removed from BD by a variety of techniques, for example by passing liquid BD over molecular sieves having a pore size smaller than 10 Angstrom units or by contacting it with alumina.

### Phosphorus-Based Ligand for Hydrocyanation Catalysts

A phosphorus-based ligand containing at least one phosphite ester bond can be a component of a hydrocyanation catalyst, such as when combined with a transition metal, e.g., nickel, as is known in the art. The metal, such as nickel, can be zero-valent, i.e., in metallic form. Reaction of the metal with the ligand can make the complex soluble in certain organic solvents. The ligand can be, for example, a phosphite, a phosphonite, a phosphinite, a phosphine, or a mixed phosphorus-based ligand or a combination of such members, provided the ligand contains at least one hydrolyzable P—O—C bond, wherein P is a phosphorus atom (which additionally bears other substituents), O is an oxygen atom, and C represent an organic radical, such as an aryl group, as described herein.

A phosphorus-based ligand can be monodentate or multidentate, for example, bidentate or tridentate. The term “monodentate” is well known in the art, and means that each molecule of the ligand possesses a single phosphorus atom (e.g., a compound of formula (IV)), which can be bonded to a single metal atom. The term “bidentate” is well known in the art, and means that each molecule of the ligand possesses two phosphorus atoms (e.g., a compound of formula (III)), and both phosphorus atoms of the ligand can be bonded to a single metal atom. The term “tridentate” means that each molecule of the ligand possesses three phosphorus atoms (e.g., a compound of formula (IIIA)), and all three phosphorus atoms on the ligand can be bonded to a single metal atom. The terms “bidentate” and “tridentate” are also known in the art as chelate ligands.

As used herein, the term “mixed phosphorus-based ligand” means a phosphorus-based ligand comprising at least one combination selected from the group consisting of a phosphite-phosphonite, a phosphite-phosphinite, a phosphite-phosphine, a phosphonite-phosphinite, a phosphonite-phosphine, and a phosphinite-phosphine or a combination of such members, provided that there is at least one P—O—C bond, wherein P is a phosphorus atom, O is an oxygen atom, and C represent an organic radical, such as an aryl group, that is subject to hydrolysis under acid catalysis.

Suitable phosphorus-based ligands for the catalyst are selected from the group consisting of ligands of formula (III), formula (IIIA), and formula (IV), or combinations thereof.

More specifically, phosphorus-based ligands useful in the synthesis of nickel-ligand hydrocyanation catalysts, for which methods and compositions of the invention provide increased stability in storage and transport, can include a bidentate phosphorus-based ligand of formula (III)

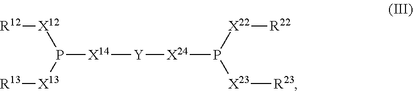

a tridentate phosphorus-based ligand of formula (IIIA)

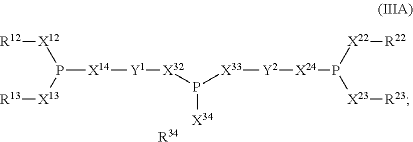

wherein for the ligand of formula (III), X¹², X¹³, X¹⁴, X²², X²³, and X²⁴, each independently is oxygen or a bond, provided that at least one of X¹², X¹³, X¹⁴, X²², X²³, or X²⁴ is oxygen, and for the ligand of formula (IIIA), X¹², X¹³, X¹⁴, X²², X²³, X²⁴, X³², X³³, and X³⁴, each independently is oxygen or a bond, provided that at least one of X¹², X¹³, X¹⁴, X²², X²³, X²⁴, X³², X³³, or X³⁴ is oxygen;

for the ligand of formula (III), R¹², R¹³, R²², and R²³, and for the ligand of formula (IIIA), R¹², R¹³, R²², R²³, and R³⁴, each independently is (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹², R¹³, R²², R²³, or R³⁴, each ring thereof is unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, one or more of pairs R¹² and R¹³ or R²² and R²³ are mutually directly bonded, such that the R¹²X¹² and R¹³X¹³ groups, or the R²²X²² and R²³X²³ groups, or both, together with the respective phosphorus atom to which each pair of groups is bonded, forms a respective ring;

for the ligand of formula (III) the group Y, and for the ligand of formula (IIIA), the groups Y¹ and Y² independently, is an (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl;

a monodentate phosphorus-based ligand of formula (IV)

P(X¹R¹)(X²R²)(X³R³) (IV)

wherein X¹, X² and X³ are each independently oxygen or a single bond, provided that at least one of X¹, X², or X³ is an oxygen; and R¹, R² and R³ is each independently (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹, R², or R³ each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, any two of R¹, R², or R³ are directly bonded to each other such that any pair of R¹X¹, R²X², and R³X³ groups, together with the phosphorus atom to which they are bonded, forms a ring; or any combination thereof. A combination of multiple ligand structures is referred to as a “ligand blend.”

Ligands and ligand blends comprising ligands of formulas (III), (IIIA), and (IV) can therefore include monodentate, bidentate, and/or tridentate ligands.

### Methods of the Invention

The inventors herein have unexpectedly discovered methods and compositions that provide for enhanced stability for phosphorus-based ligands such as those described herein, enabling these ligands to be stored, transported, etc. with a reduced loss by degradation. The inventors herein have found that use of particular liquids as diluents and types of containers for storage of the ligands and blends can provide enhanced ligand stability over a period of time, such that when the ligands are incorporated into catalytic metal-ligand complexes for hydrocyanation reactions, more favorable activity of the catalyst can be achieved. Accordingly, the invention can provide a method of stabilizing a phosphorus-based ligand or a ligand blend, such as for storage and transport, comprising a plurality of phosphorus-based ligands, the ligand or ligand blend being for formation of a metal-ligand complex for catalysis of a hydrocyanation reaction, wherein the ligand or ligand blend comprises one or more of:

a bidentate phosphorus-based ligand of formula (III)

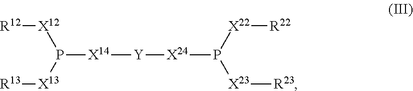

or,

a tridentate phosphorus-based ligand of formula (IIIA)

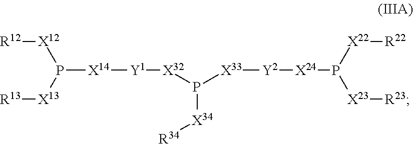

wherein for the ligand of formula (III), X¹², X¹³, X¹⁴, X²², X₂₃, and X²⁴, each independently is oxygen or a bond, provided that at least one of X¹², X¹³, X¹⁴, X²², X²³, or X²⁴ is oxygen, and for the ligand of formula (IIIA), X¹², X¹³, X¹⁴, X²², X²³, X²⁴, X³², X³³, and X³⁴, each independently is oxygen or a bond, provided that at least one of X¹², X¹³, X¹⁴, X²², X²³, X²⁴, X³², X³³, or X³⁴ is oxygen;

for the ligand of formula (III), R¹², R¹³, R²², and R²³, and for the ligand of formula (IIIA), R¹², R¹³, R²², R²³, and R³⁴, each independently is (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹², R¹³, R²², R²³, or R³⁴, each ring thereof is unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, one or more of pairs R¹² and R¹³ or R²² and R²³ are mutually directly bonded, such that the R¹²X¹² and R¹³X¹³ groups, or the R²²X²² and R²³X²³ groups, or both, together with the respective phosphorus atom to which each pair of groups is bonded, forms a respective ring;

for the ligand of formula (III) the group Y, and for the ligand of formula (IIIA), the groups Y¹ and Y² independently, is an (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl;

or, a monodentate phosphorus-based ligand of formula (IV)

P(X¹R¹)(X²R²)(X³R³) (IV)

wherein X¹, X² and X³ are each independently oxygen or a single bond, provided that at least one of X¹, X², or X³ is an oxygen; and R¹, R² and R³ is each independently (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹, R², or R³ each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, any two of R¹, R², or R³ are directly bonded to each other such that any pair of R¹X¹, R²X², and R³X³ groups, together with the phosphorus atom to which they are bonded, forms a ring;

the process comprising forming a mixture of the ligand or the ligand blend with a liquid which partially or fully solubilizes the ligand or ligand blend, the liquid consisting essentially of one or more of:

(a) a solvent system that does not contain peroxidizable species; or,

(b) a solvent system that is substantially free of a dissolved metal;

wherein the process optionally further comprises utilizing a container to contain the mixture of the ligand or ligand blend and the liquid, the container having an inner surface in contact with the liquid that does not leach a metal into the liquid.

For example, the invention can provide a method for stabilizing a ligand or ligand blend wherein the liquid in which the ligand or the ligand blend is partially or fully solubilized comprises a hydrocarbon. More specifically, the hydrocarbon can be an aromatic hydrocarbon, a cyclic hydrocarbon or a saturated hydrocarbon, or a mixture thereof. Or, the liquid can comprise acetonitrile. The liquid can be free of a solvent system containing a peroxidizable species. By a “peroxidizable species” is meant a chemical entity that is prone to reaction with an oxidant such as atmospheric oxygen at standard temperature and pressure that results in production of peroxides, that is, organic compounds containing O—O bonds. Accordingly, the invention can provide a liquid consisting essentially of a solvent system that does not include an alkene, an ether, an acetal, a dioxane, an ethylene glycol ether, an acetate, a vinyl ether, or a secondary alcohol, or any mixture thereof, because these are examples of peroxidizable species. As is well known in the art, alkenes and ethers can react with atmospheric oxygen to yield reactive organic peroxide compounds. Furthermore, the inventors herein have discovered that the storage stability of ligands and blends as described is improved when the diluent liquid described above contains less than 100 ppm water, or contains less than 50 ppm elemental oxygen, or is substantially free of a dissolved metal, e.g., nickel, or any combination thereof.

The inventors herein have further discovered that enhanced storage stability of the ligand or blend can be achieved when the ligand and liquid, as described above, is stored in a container wherein the container inner surface in contact with the liquid does not leach a metal into the liquid. For example, the container inner surface can be coated with a polymer. The invention can provide a method for providing enhanced storage stability for a ligand or blend, at least partially solubilized in a liquid as specified herein, wherein a step of monitoring an amount of peroxides in the liquid after forming the mixture of the ligand or ligand blend and the liquid can be performed.

Ligands that may be stored or transported with enhanced stability using a method of the invention include examples where, for the ligand of formula (III) or formula (IIIA) or formula (IV), each respective R¹, R², R³, R¹², R¹³, R²², R²³ or R³⁴ can be each an independently selected (C6-C20)aryl group, wherein each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl and (C6-C20)aryl(C1-C10)alkyl, or wherein any one or more pair of R¹ and R², or R¹² and R¹³, or R²² and R²³, is directly mutually bonded such that any mutually bonded pair, together with the respective X¹, X², X¹², X¹³, X²² or X²³ groups and the phosphorus atom to which they are bonded, forms a ring.

More specifically, for the ligands as defined, each independently selected R¹, R², R³, R¹², R¹³, R²², R²³ or R³⁴ is a group of formula (II)

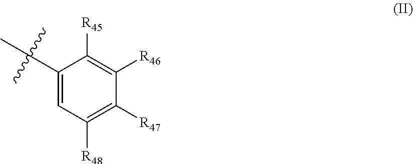

wherein a wavy line indicates a point of attachment; and wherein R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy.

Also, for the ligands as defined, Y, or independently selected Y¹ or Y², can be a (C6-C20)arylene group, wherein each ring thereof is independently unsubstituted or is substituted with 1-4 (C1-C10)alkyl, (C3-C10)cycloalkyl, (C1-C10)alkoxy, (C3-C10)cyclo alkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl.

The invention can provide methods and compositions for increased stability in storage and transport for phosphorus-based ligands wherein the ligand of formula (III) is of formula (X):

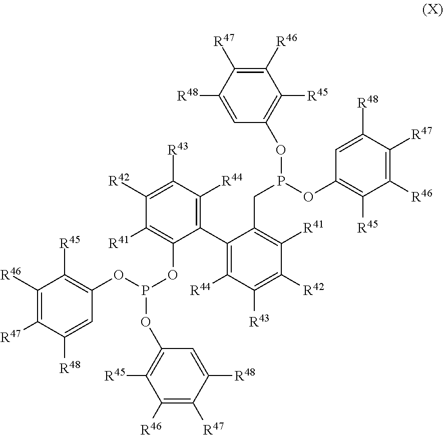

wherein each R⁴¹ and R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴², R⁴³, R⁴⁴, R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy. More specifically, for the ligand of formula (X),
R⁴¹ is methyl, ethyl, isopropyl or cyclopentyl;
R⁴² is H or methyl;
R⁴³ is H or (C1-C4)alkyl;
R⁴⁴ is H or methyl;
R⁴⁵ is methyl, ethyl, or isopropyl; and
R⁴⁶, R⁴⁷ and R⁴⁸ are independently H or (C1-C4)alkyl.

The invention can provide methods and compositions for increased stability in storage and transport for phosphorus-based ligands wherein the ligand of formula (III) is of formula (VII):

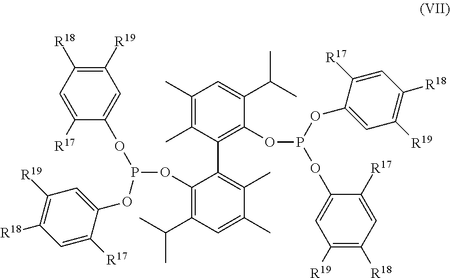

wherein R¹⁷ is methyl, ethyl or isopropyl, and R¹⁸ and R¹⁹ are independently H or methyl. More specifically, the ligand of formula (III) is of formula (XII)

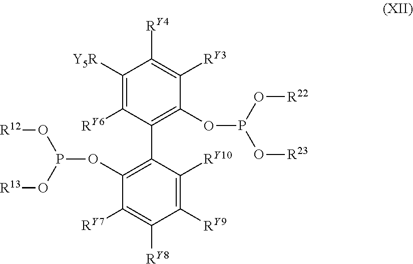

wherein R¹², R¹³, R²² and R²³ are each independently an unsubstituted or a substituted monovalent aryl, and each of R^{Y3}—R^{Y10} is independently selected from the group consisting of hydrogen, (C1-C10)alkyl, and (C1-C10)alkoxy, or wherein two adjacent R^{Y3}—R^{Y19} groups together form an optionally substituted fused aryl ring.

More specifically, for example, R¹², R¹³, R²², and R²³ are each independently phenyl substituted at a respective single ortho-position with a (C1-C10)alkyl or (C1-C10)alkoxy, wherein respective meta- and para-positions of the R¹², R¹³, R²², and R²³ phenyls can each independently be unsubstituted or be independently substituted with (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, or (C3-C10)cycloalkoxy(C1-C10)alkoxy; and, R^{Y6} and R^{Y10} are independently (C1-C10)alkyl or (C1-C10)alkoxy, and R^{Y3}, R^{Y4}, R^{Y5}, R^{Y7}, R^{Y8}, and R^{Y9}, are independently H, (C1-C10)alkyl, or (C1-C10)alkoxy, provided that at least one of R^{Y3}, R^{Y4}, or R^{Y5}, and at least one of R^{Y7}, R^{Y8}, or R^{Y9}, is (C1-C10)alkyl or (C1-C10)alkoxy.

More specifically, the ligand of formula (III) can be of formula (V):

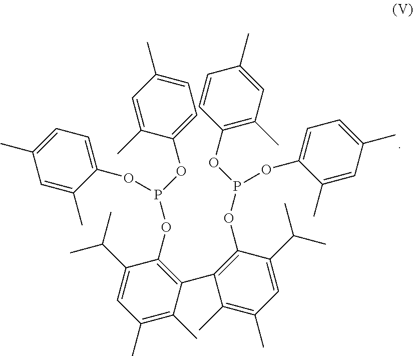

The invention can provide methods and compositions for increased stability in storage and transport for phosphorus-based ligands wherein for ligands of formulas (III), (IIIA), and (IV), wherein the one or more monodentate ligand of formula (IV) is each independently of formula (IVA)

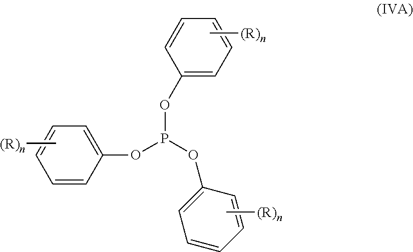

wherein each R is independently methyl and each n is independently 0, 1, or 2. More specifically, particular compounds which may be used are those of the formula (IVA) above, such as a ligand of the general formula (o-tolyl-O—)_{w}(m-tolyl-O—)ₓ(p-tolyl-O—)_{y}(phenyl-O—)_{z}P where w, x, y, z are each a natural number and the following conditions apply: w+x+y+z=3 and z=less than or equal to 2.
Examples of such compounds (IVa) are (o-tolyl-O—)₃P, (p-tolyl-O—)(phenyl-O—)₂P, (m-tolyl-O—)(phenyl-O—)₂P, (o-tolyl-O—)(phenyl-O—)₂P, (p-tolyl-O—)₂(phenyl-O—)P, (m-tolyl-O—)₂(phenyl-O—)P, (o-tolyl-O—)₂(phenyl-O—)P, (m-tolyl-O—)(p-tolyl-O—)(phenyl-O—)P, (o-tolyl-O—)(p-tolyl-O—)(phenyl-O—)P, (o-tolyl-O—)(m-tolyl-O—)(phenyl-O—)P, (p-tolyl-O—)₃P, (m-tolyl-O—)(p-tolyl-O—)₂P, (o-tolyl-O—)(p-tolyl-O—)₂P, (m-tolyl-O—)₂(p-tolyl-O—)P, (o-tolyl-O—)₂(p-tolyl-O—)P, (o-tolyl-O—)(m-tolyl-O—)(p-tolyl-O—)P, (m-tolyl-O—)₃P, (o-tolyl-O—)(m-tolyl-O—)₂P, (o-tolyl-O—)₂(m-tolyl-O—)P or mixtures of such compounds.

More specifically, the monodentate ligand of formula (IV) can be a ligand of formula (XIII):

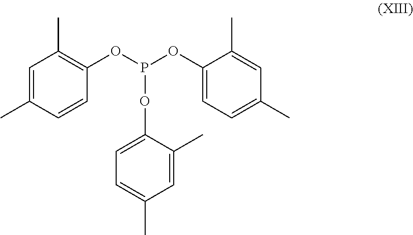

or a ligand of formula (XIV):

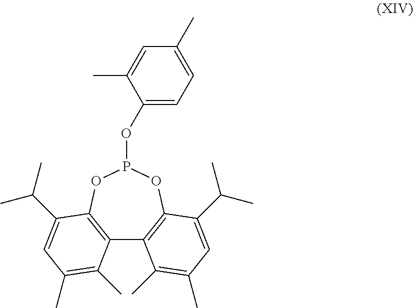 [SMILES: Cc1ccc(Op2oc3c(C(C)C)cc(C)c(C)c3c3c(C)c(C)cc(C(C)C)c3o2)c(C)c1]

or a mixture thereof.

The invention can provide methods and compositions for increased stability in storage and transport for phosphorus-based ligands wherein for ligands of formulas (III), (IIIA), and (IV), wherein the ligand blend comprises a mixture of a bidentate ligand of formula (V):

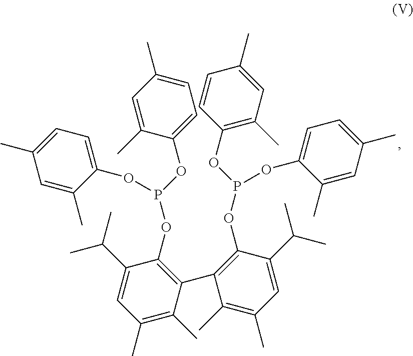

a monodentate ligand of formula (XIII):

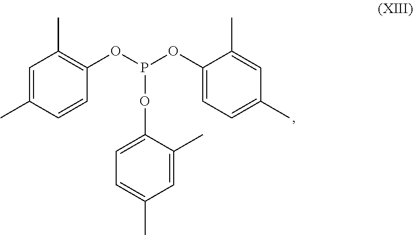

and, a monodentate ligand of formula (XIV):

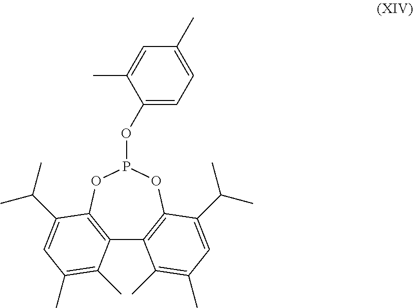 [SMILES: Cc1ccc(Op2oc3c(C(C)C)cc(C)c(C)c3c3c(C)c(C)cc(C(C)C)c3o2)c(C)c1]

It will be recognized that Formulae (V) to (XI) are two-dimensional representations of three-dimensional molecules and that rotation about chemical bonds can occur in the molecules to give configurations differing from those shown. For example, rotation about the carbon-carbon bond between the 2- and 2′-positions of the biphenyl, octahydrobinaphthyl, and or binaphthyl bridging groups of Formulae (V) to (XI), respectively, can bring the two phosphorus atoms of each Formula in closer proximity to one another and can allow the phosphite ligand to bind to nickel in a bidentate fashion. The term “bidentate” is well known in the art and means both phosphorus atoms of the ligand are bonded to a single nickel atom. In addition, use of an optically active moiety such as sec-butyl for R⁴¹ can result in optically active catalysts.

As described above, the liquid in which the ligand or ligand blend is at least partially solubilized can comprise a hydrocarbon, such as an aromatic, cyclic, or saturated hydrocarbon. More specifically, the liquid can comprise cyclohexane. Also, the liquid can contain less than 100 ppm water, less than 50 ppm elemental oxygen, and the inner surface of the container can comprise a polymer coating, to provide enhanced storage stability for the ligand or ligand blend. For example the container can have an interior surface that does not leach a metal into the liquid to a concentration in excess of 100 ppm.

The invention can provide methods and compositions for increased stability in storage and transport for phosphorus-based ligands, for example, the invention can provide a stabilized composition comprising a phosphorus-based ligand or a ligand blend comprising a plurality of phosphorus-based ligands, the ligand or ligand blend being for formation of a metal-ligand complex for catalysis of a hydrocyanation reaction, wherein the ligand or ligand blend comprises one or more of:

a bidentate phosphorus-based ligand of formula (III)

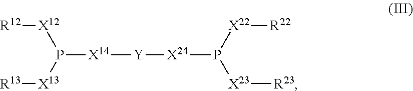

or,

a tridentate phosphorus-based ligand of formula (IIIA)

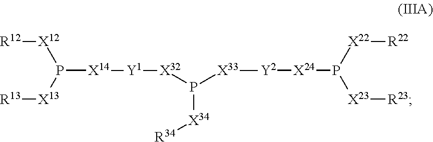

wherein for the ligand of formula (III), X¹², X¹³, X¹⁴, X²², X²³, and X²⁴, each independently is oxygen or a bond, provided that at least one of X¹², X¹³, X¹⁴, X²², X²³, or X²⁴ is oxygen, and for the ligand of formula (ITU), X¹², X¹³, X¹⁴, X²², X²³, X²⁴, X³², X³³, and X³⁴, each independently is oxygen or a bond, provided that at least one of X¹², X¹³, X¹⁴, X²², X²³, X²⁴, X³², X³³, or X³⁴ is oxygen;

for the ligand of formula (III), R¹², R¹³, R²², and R²³, and for the ligand of formula (IIIA), R¹², R¹³, R²², R²³, and R³⁴, each independently is (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹², R¹³, R²², R²³, or R³⁴, each ring thereof is unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, one or more of pairs R¹² and R¹³ or R²² and R²³ are mutually directly bonded, such that the R¹²X¹² and R¹³X¹³ groups, or the R²²X²² and R²³X²³ groups, or both, together with the respective phosphorus atom to which each pair of groups is bonded, forms a respective ring;

for the ligand of formula (III) the group Y, and for the ligand of formula (IIIA), the groups Y¹ and Y² independently, is an (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl;

or, a monodentate phosphorus-based ligand of formula (IV)

P(X¹R¹)(X²R²)(X³R³) (IV)

wherein X¹, X² and X³ are each independently oxygen or a single bond, provided that at least one of X¹, X², or X³ is an oxygen; and R¹, R² and R³ is each independently (C1-C10)alkyl, (C3-C10)cycloalkyl, (C3-C10)cycloalkyl(C1-C0)alkyl, (C6-C20)aryl, or (C6-C20)aryl(C1-C10)alkyl, wherein for any (C6-C20)aryl or (C6-C20)aryl(C1-C10)alkyl of R¹, R², or R³ each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, any two of R¹, R², or R³ are directly bonded to each other such that any pair of R¹X¹, R²X², and R³X³ groups, together with the phosphorus atom to which they are bonded, forms a ring;

and, a liquid which partially or fully solubilizes the ligand or ligand blend, the liquid consisting essentially of one or more of:

(a) a solvent system that does not contain peroxidizable species; or,

(b) a solvent system that is substantially free of a dissolved metal.

Accordingly, the invention can provide a stabilized composition wherein the composition exhibits reduced ligand degradation relative to the ligand or ligand blend in a liquid under comparable conditions wherein the solvent system contains peroxidizable species or a dissolved metal, or both. The liquid in which the ligand or the ligand blend is partially or fully solubilized can comprise a hydrocarbon, such as an aromatic hydrocarbon, a cyclic hydrocarbon, or a saturated hydrocarbon, or a mixture thereof. Or, the liquid can comprise acetonitrile. To avoid peroxidizable species, as described above, for example, the liquid can exclude as a component an an alkene, an ether, an acetal, a dioxane, an ethylene glycol ether, an acetate, a vinyl ether, or a secondary alcohol, or any mixture thereof.

The invention can provide compositions for increased stability in storage and transport for phosphorus-based ligands, wherein the liquid in which the ligand or blend is at least partially solubilized contains less than 100 ppm water, or contains less than 50 ppm elemental oxygen, or contains less than 100 ppm of a dissolved metal, or any combination thereof. For example, the liquid can contain less than 100 ppm of dissolved nickel.

For the sake of brevity, the various examples of ligands of formulas (III), (IIIA), and (IV) are not recapitulated here, but it is understood that the same ligands, e.g., of formulas (V)-(XIV), can be present in a stabilized composition of the invention as can be used in practice of a method of the invention.

Specifically, the stabilized composition can include a ligand blend comprising a mixture of a bidentate ligand of formula (V):

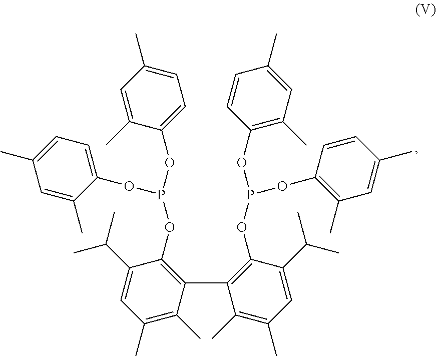

a monodentate ligand of formula (XIII):

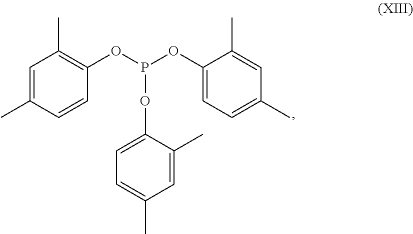

and, a monodentate ligand of formula (XIV):

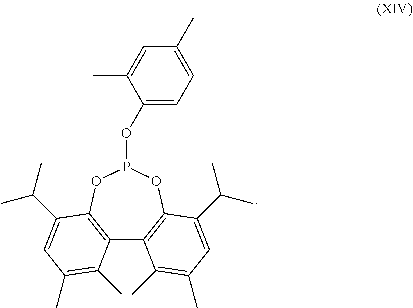 [SMILES: Cc1ccc(Op2oc3c(C(C)C)cc(C)c(C)c3c3c(C)c(C)cc(C(C)C)c3o2)c(C)c1]

The stabilized composition of the invention can include a liquid comprising cyclohexane, containing less than 100 ppm water, and less than 50 ppm elemental oxygen. The stabilized composition can be contained in a storage container, the container having an inner surface in contact with the liquid that does not leach a metal, e.g., does not leach nickel, into the liquid, or does not leach a metal into the liquid to a concentration in excess of 100 ppm. For example, the inner surface of the container can be coated with a polymer.

### Solvents for Catalyst Storage and Shipment

The ligand catalysts are particularly stored and shipped according to the present invention in a solvent system comprising one or more liquid solvents which have a reduced tendency to form peroxides which may accelerate air oxidation of the ligand through hydroperoxide intermediates. Such useful solvents for the invention include toluene, cyclohexane, hexane, heptane and acetonitrile. In particular, so-called “dry” solvents which have been subjected to a drying process to reduce water content may be used in the present invention. Thus, toluene, cyclohexane and acetonitrile with less than 100 ppm of water may suitably be used.

In particular, the solvent system for the invention includes levels of potential peroxide-forming solvents less than 10% by weight, particularly less than 1% by weight of such solvents. Such potential peroxide-forming solvents that can be excluded from the liquid include an acetal, a dioxane, an ethylene glycol ether, an acetate, a vinyl ether, an alkene and a secondary alcohol. Specific potential peroxide-forming solvents that can be excluded include isopropyl ether, acetaldehyde, benzyl alcohol, 2-butanol, chlorofluoroethylene, isopropylbenzene (cumene), cyclohexene, 2-cyclohexen-1-ol, cyclopentene, decahydronapthalene (decalin), diacetylene (butadiyne), dicyclopentadiene (DCPD), diglyme, diethyl ether, furan, 4-heptanol, 2-hexanol, methylacetylene, 3-methyl-1-butanol, methylisobutyl ketone, 4-methyl-2-pentanol, 2-pentanol, 4-penten-1-ol, 1-phenylethanol, tetrahydrofuran, 2-pentenenitrile, 2-methyl-3-butenenitrile, 2-methyl-2-butenenitrile, 3-pentenenitrile, and 4-pentenenitrile, and tetrahydronapthalene.

The presence of peroxides may be tested as known in the art such as by use of a potassium iodide indicator or a Quantofix Peroxide Test Strip supplied by Sigma-Aldrich of St. Louis, Mo.

### Containers for Catalyst Storage and Shipment

Containers such as barrels, drums, of various sizes and shapes may be used for the storage and transport of the catalyst ligand according to the invention. In particular, containers which allow ingress and egress of contents with minimal exposure to the atmosphere and other sources of oxygen may be used. Polymeric materials are particularly used for any contact with the ligand catalyst. Collapsible drums suitable for catalyst ligand storage and transport are described in WO 2011/094411 published 4 Aug. 2011 and assigned to Pack-Gen of Auburn, Me. USA. Materials used for such containers and coming into contact with the catalyst ligand include polymers such as polyethylene terephthalate (PET), polyethylene napthalate (PEN), polypropylene and polyethylene as well as metal containers that are resistant to leaching by the ligand catalyst. Containers having an oxygen-scavenging core layer are described in U.S. Pat. No. 7,056,565 issued to Chevron and various structural and chemical compositional aspects of the container may be used in the present invention.

Containers for oxygen-sensitive products are described in U.S. Pat. No. 7,854,973 issued to Sonoco wherein an oxidation catalyst is provided in a first outer layer to consume oxygen which diffuses into the interior. Various structural and chemical compositional aspects of U.S. Pat. No. 7,854,973 may be used in the container of present invention, provided that the mechanism for scavenging the oxygen does not oxidize the ligand. Wall layers are provided which may be an ethylene-vinyl alcohol copolymer, polyamide homo or copolymer, polyacrylonitrile copolymer, polyvinyl chloride (PVC) or other polymer with low oxygen permeability.

Catalyst container structures described in U.S. Pat. No. 4,946,068 issued to Amoco and WO 2006/052677 issued to Exxon-Mobil for catalyst storage, transfer and dispensing may be used in the present invention.

Thermoplastic containers for the storage and transportation of dangerous liquid fillings are described in EP 0 673 841 issued to Mauser-Werke of Bruhl, Germany.

### Headspace for Containers

Inert atmospheric packaging (IAP) or modified atmosphere packaging (MAP) can be used in the processes and products of the invention. Thus, charging of the ligand/solvent mixture for storage or shipment into an appropriate container is accompanied by, followed by or both, rendering the headspace above the liquid surface as an inert or very low reactivity atmosphere.

### EXAMPLES

Diphosphite ligand was prepared according to the procedure published in International Application Number PCT/US10/60381, International Application Number PCT/US10/60388, International Application Number PCT/US11/40193. The ligand of formula (V) solution was a mixture in cyclohexane with the major component (exclusive of solvent) being ligand of formula (V), but also including ligands of formulas (XIII) and (XIV), and hydrolysis products of ligands of formulas (V), (XIII) and (XIV), and other products derived from the compounds used for their synthesis. A portion of the toluene was distilled and the ligand mixture subsequently dissolved in cyclohexane. An example composition of the ligand solution in cyclohexane analyzed by high-pressure liquid chromatography (LC) analysis is given in Table 1 and by ³¹P NMR in Table 2.

### Example 1

### (V) Ligand Solution in Cyclohexane was Exposed to Air

The experiment was conducted in a 125 ml serum bottle. The 125 ml serum bottle was charged with 10 g of (V) solution in an oxygen free glovebox and a magnetic stir bar. The container was taken out of the glovebox and serum bottle headspace was exchanged with air. The solution was stirred at room temperature and sampled after 30 minutes and 24 hours. Results listed in Table 1 and 2.

### Example 2

### (V) Ligand Solution in Cyclohexane with Dissolved Nickel was Exposed to Air

The experiment was conducted in a 125 ml serum bottle. The 125 ml serum bottle was charged with 9.7 g of (V) solution and 0.3 g of nickel containing (V) solution prepared from nickel metal according procedure published in International Application Number PCT/US2011/040193 in an oxygen free glovebox and a magnetic stir bar. The container was taken out of the glovebox and serum bottle headspace was exchanged with air. The solution was stirred at room temperature and sampled after 30 minutes and 24 hours. Results listed in Table 1 and 2.

### Example 3

### (V) Ligand Solution in Cyclohexane with Dissolved Nickel was Exposed to Air

The experiment was conducted in a 125 ml serum bottle. The 125 ml serum bottle was charged with 9.25 g of V solution and 0.75 g of nickel containing (V) solution prepared from nickel metal according procedure published in International Application Number PCT/US2011/040193 in an oxygen free glovebox and a magnetic stir bar. The container was taken out of the glovebox and serum bottle headspace was exchanged with air. The solution was stirred at room temperature and sampled after 30 minutes and 24 hours. Results listed in Table 1 and 2.

### Example 4

### (V) Ligand Solution in Cyclohexane with Dissolved Nickel was Exposed to Air

The experiment was conducted in a 125 ml serum bottle. The 125 ml serum bottle was charged with 10 g of (V) solution and 0.0052 g of bis(1,5-cyclooctadiene) nickel in an oxygen free glovebox and a magnetic stir bar. The container was taken out of the glovebox and serum bottle headspace was exchanged with air. The solution was stirred at room temperature and sampled after 30 minutes and 24 hours. Results listed in Table 1 and 2.

### Example 5

### V Ligand Solution in Cyclohexane with Pentenenitrile Isomer Mixture was Exposed to Air

The experiment was conducted in a 125 ml serum bottle. The 125 ml serum bottle was charged with 9.0 g of (V) solution and 1.0 g of pentenenitrile isomer mixture in an oxygen free glovebox and a magnetic stir bar. The container was taken out of the glovebox and serum bottle headspace was exchanged with air. The solution was stirred at room temperature and sampled after 30 minutes and 24 hours. Results listed in Table 1 and 2.

### Example 6

### V Ligand Solution in Cyclohexane with Pentenenitrile Isomer Mixture which was Previously Exposed to Air

The experiment was conducted in a 125 ml serum bottle. The 125 ml serum bottle was charged with 9.0 g of (V) solution and 1.0 g of pentenenitrile isomer mixture that had been exposed to 6.5% oxygen by volume for 32 hours at room temperature. The serum bottle headspace was exchanged with air. The solution was stirred at room temperature and sampled after 30 minutes and 24 hours. Results listed in Table 1 and 2.

TABLE 1

| | | | | | | Molar ratio % of | |
|---|---|---|---|---|---|---|---|
| | | % wt by LC analysis | | | | V oxidation | % change in |
| | Time exposed | | | | Oxidation product | product to V + V | oxidation |
| Example | to Air | 7 | 8 | V | of V | oxidation product | products |
| Example 1 | 0 | 4.4 | 2.4 | 34.5 | 0.346 | 0.98% | 0% |
| Example 1 | 0.5 hours | 4.5 | 2.5 | 35.3 | 0.344 | 0.95% | −3% |
| Example 1 | 24 hours | 4.5 | 2.6 | 35.1 | 0.336 | 0.93% | −5% |
| Example 2 | 0 | 4.4 | 2.5 | 34.0 | 0.339 | 0.97% | 0% |
| Example 2 | 0.5 hours | 4.4 | 2.5 | 34.0 | 0.487 | 1.39% | 43% |
| Example 2 | 24 hours | 4.4 | 2.5 | 34.2 | 0.508 | 1.44% | 48% |
| Example 3 | 0 | 4.2 | 2.4 | 33.2 | 0.367 | 1.07% | 0% |
| Example 3 | 0.5 hours | 4.2 | 2.4 | 32.8 | 0.627 | 1.84% | 72% |
| Example 3 | 24 hours | 4.1 | 2.4 | 32.3 | 0.794 | 2.36% | 120% |
| Example 4 | 0 | 4.4 | 2.5 | 34.5 | 0.343 | 0.97% | 0% |
| Example 4 | 0.5 hours | 4.5 | 2.6 | 35.0 | 0.560 | 1.54% | 60% |
| Example 4 | 24 hours | 4.4 | 2.5 | 34.7 | 0.585 | 1.63% | 68% |
| Example 5 | 0 | 3.9 | 2.3 | 30.9 | 0.332 | 1.04% | 0% |
| Example 5 | 0.5 hours | 4.0 | 2.3 | 31.3 | 0.338 | 1.05% | 0% |
| Example 5 | 24 hours | 3.9 | 2.3 | 31.3 | 0.379 | 1.18% | 13% |
| Example 6 | 0 | 4.0 | 2.3 | 31.2 | 0.350 | 1.09% | 0% |
| Example 6 | 0.5 hours | 4.0 | 2.3 | 31.4 | 0.379 | 1.17% | 8% |
| Example 6 | 24 hours | 4.0 | 2.3 | 31.2 | 0.423 | 1.31% | 21% |

TABLE 2

| | | % P molar ratio | | | | % change |
|---|---|---|---|---|---|---|
| | | | | | Oxidation | in Oxida- |
| | | | | | products | tion prod- |
| | | | | | of 7, 8, | ucts after |
| Example | Time | 7 | 8 | V | and V | 24 hours |
| Example 1 | Initial | 12.2% | 4.7% | 79.3% | 0.29% | |
| Example 1 | 24 hours | 12.2% | 4.7% | 79.7% | 0.28% | −4.0% |
| Example 2 | Initial | 12.9% | 4.8% | 78.8% | 0.39% | |
| Example 2 | 24 hours | 12.3% | 4.9% | 79.0% | 0.78% | 99.1% |
| Example 3 | Initial | 12.9% | 5.0% | 78.7% | 0.56% | |
| Example 3 | 24 hours | 12.3% | 4.9% | 78.4% | 1.78% | 221.4% |
| Example 4 | Initial | 11.5% | 4.9% | 80.0% | 0.36% | |
| Example 4 | 24 hours | 12.6% | 4.8% | 78.5% | 0.98% | 171.0% |
| Example 5 | Initial | 12.0% | 4.8% | 79.5% | 0.34% | |
| Example 5 | 24 hours | 12.0% | 4.8% | 79.5% | 0.42% | 21.2% |
| Example 6 | Initial | 11.3% | 4.8% | 80.2% | 0.47% | |
| Example 6 | 24 hours | 12.1% | 5.0% | 78.9% | 0.56% | 19.0% |

The data presented in Table 1 and Table 2 show that Ligand (XIII), Ligand (XIV), and Ligand (V) are stable when stored in the absence of dissolved nickel, when exposed to air, as shown by Example 1, and are unstable when stored in the presence of dissolved nickel and exposed to air, as evidenced by Example 2, Example 3, and Example 4. Further, in all cases when Ligand (XIII), Ligand (XIV), and Ligand (V) were exposed to air in presence of dissolved nickel, regardless of the nickel source, the ligands are destroyed, as shown in Example 2, Example 3, and Example 4. Additionally, the Ligand (XIII), Ligand (XIV), and Ligand (V) are unstable when exposed to air in presence of dissolved nickel, wherein the source of the dissolved nickel was bulk nickel metal, as demonstrated in Example 2 and Example 3. Additionally, it was demonstrated that when a peroxidizable solvent is present in the mixture that Ligand (XIII), Ligand (XIV), and Ligand (V) are not stable when exposed to air, as shown by Example 5, and Example 6.

### STATEMENTS OF THE INVENTION

1. A method of stabilizing a phosphorus-based ligand or a ligand blend comprising a plurality of phosphorus-based ligands, the ligand or ligand blend being for formation of a metal-ligand complex for catalysis of a hydrocyanation reaction, wherein the ligand or ligand blend comprises one or more of:

a bidentate Phosphorus-based ligand of formula (III)

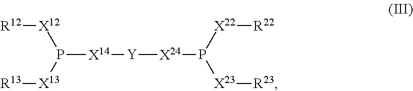

or,

a tridentate phosphorus-based ligand of formula (IIIA)

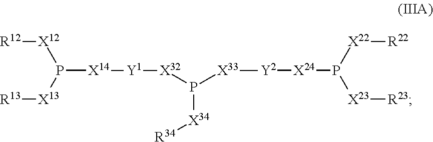

wherein for the ligand of formula (III), X¹², X¹³, X¹⁴, X²², X²³, and X²⁴, each independently is oxygen or a bond, provided that at least one of X¹², X¹³, X¹⁴, X²², X²³, or X²⁴ is oxygen, and for the ligand of formula (IIIA), X¹², X¹³, X¹⁴, X²², X²³, X²⁴, X³², X³³ and X³⁴, each independently is oxygen or a bond, provided that at least one of X¹², X¹³, X¹⁴, X²², X²³, X²⁴, X³², X³³, or X³⁴ is oxygen;

for the ligand of formula (III), R¹², R¹³, R²², and R²³, and for the ligand of formula (IIIA), R¹², R¹³, R²², R²³, and R³⁴, each independently is (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹², R¹³, R²², R²³, or R³⁴, each ring thereof is unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, one or more of pairs R¹² and R¹³ or R²² and R²³ are mutually directly bonded, such that the R¹²X¹² and R¹³X¹³ groups, or the R²²X²² and R²³X²³ groups, or both, together with the respective phosphorus atom to which each pair of groups is bonded, forms a respective ring;

for the ligand of formula (III) the group Y, and for the ligand of formula (IIIA), the groups Y¹ and Y² independently, is an (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl;

or, a monodentate phosphorus-based ligand of formula (IV)

P(X¹R¹)(X²R²)(X³R³) (IV)

wherein X¹, X² and X³ are each independently oxygen or a single bond, provided that at least one of X¹, X², or X³ is an oxygen; and R¹, R² and R³ is each independently (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹, R², or R³ each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, any two of R¹, R², or R³ are directly bonded to each other such that any pair of R¹X¹, R²X², and R³X³ groups, together with the phosphorus atom to which they are bonded, forms a ring;

the process comprising forming a mixture of the ligand or the ligand blend with a liquid which partially or fully solubilizes the ligand or ligand blend, the liquid consisting essentially of one or more of:

(a) a solvent system that does not contain peroxidizable species; or,

(b) a solvent system that is substantially free of a dissolved metal;

wherein the process optionally further comprises utilizing a container to contain the mixture of the ligand or ligand blend and the liquid, the container having an inner surface in contact with the liquid that does not leach a metal into the liquid.
2. The method of statement 1, wherein the liquid in which the ligand or the ligand blend is partially or fully solubilized comprises a hydrocarbon, or comprises acetonitrile, or both.
3. The method of statement 2, wherein the hydrocarbon is an aromatic hydrocarbon, a cyclic hydrocarbon or a saturated hydrocarbon, or a mixture thereof.
4. The method of any one of statements 1-3, wherein the liquid does not include an alkene, an ether, an acetal, a dioxane, an ethylene glycol ether, an acetate, a vinyl ether, or a secondary alcohol, or any mixture thereof.
5. The method of any one of statements 1-4, wherein the container inner surface in contact with the liquid does not leach a metal into the liquid.
6. The method of any one of statements 1-5, wherein the liquid contains less than 100 ppm water.
7. The method of any one of statements 1-6, wherein the liquid contains less than 50 ppm elemental oxygen.
8. The method of any one of statements 1-7, wherein the liquid is substantially free of a dissolved metal.
9. The method of statement 8, wherein the liquid is substantially free of dissolved nickel.
10. The method of any one of statements 1-9, further comprising the step of monitoring an amount of peroxides in the liquid after forming the mixture of the ligand or ligand blend and the liquid.
11. The method of any one of statements 1-10, wherein for the ligand of formula (III) or formula (IIIA) or formula (IV), each respective R¹, R², R³, R¹², R¹³, R²², R²³ or R³⁴, is each an independently selected (C6-C20)aryl group, wherein each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl and (C6-C20)aryl(C1-C10)alkyl, or wherein any one or more pair of R¹ and R², or R¹² and R¹³, or R²² and R²³, is directly mutually bonded such that any mutually bonded pair, together with the respective X¹, X², X¹², X¹³, X²² or X²³ groups and the phosphorus atom to which they are bonded, forms a ring.
12. The method of any one of statements any one of statements 1-10, wherein each independently selected R¹, R², R³, R¹², R¹³, R²², R²³ or R³⁴ is a group of formula (II)

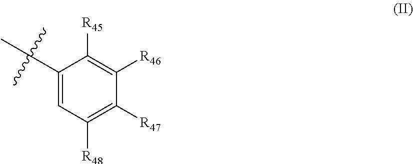

wherein a wavy line indicates a point of attachment; and wherein R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy.

13. The method of any one of statements 1-10, wherein Y, or independently selected Y¹ or Y², is a (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl.
14. The method of any one of statements 1-10, wherein the ligand of formula (III) is of formula (X):

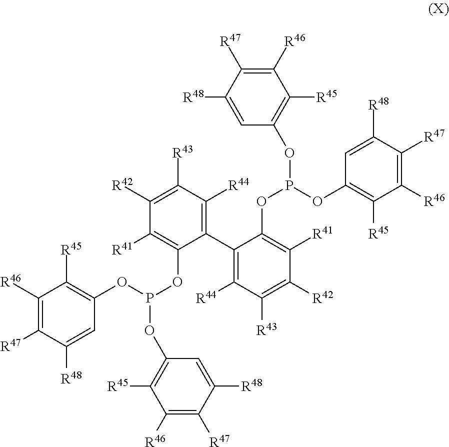

wherein each R⁴¹ and R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴², R⁴³, R⁴⁴, R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy.
15. The method of statement 14, wherein for the ligand of formula (X),
R⁴¹ is methyl, ethyl, isopropyl or cyclopentyl;
R⁴² is H or methyl;
R⁴³ is H or (C1-C4)alkyl;
R⁴⁴ is H or methyl;
R⁴⁵ is methyl, ethyl, or isopropyl; and
R⁴⁶, R⁴⁷ and R⁴⁸ are independently H or (C1-C4)alkyl.
16. The method of any one of statements 1-10, wherein the ligand of formula (III) is of formula (VII):

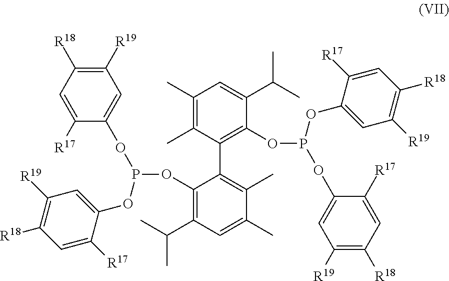

wherein R¹⁷ is methyl, ethyl or isopropyl, and R¹⁸ and R¹⁹ are independently H or methyl.
17. The method of any one of statements 1-10, wherein the ligand of formula (III) is of formula (XII)

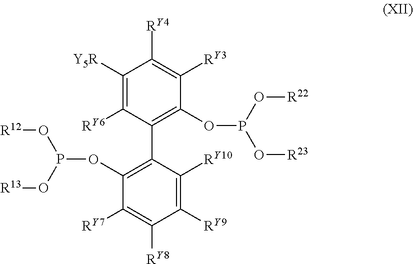

wherein for the ligand of formula (XII), R¹², R¹³, R²², and R²³ are each independently phenyl substituted at a respective first ortho-position with a (C1-C10)alkyl or (C1-C10)alkoxy, at a respective second ortho-position with hydrogen, and wherein respective meta- and para-positions of the R¹², R¹³, R²², and R²³ phenyls can each independently be unsubstituted or be independently substituted with 1-3 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, or (C3-C10)cycloalkoxy(C1-C10)alkoxy.
18. The method of statement 17, wherein R¹², R¹³, R²², and R²³ are each independently phenyl substituted at a respective single ortho-position with a (C1-C10)alkyl or (C1-C10)alkoxy, wherein respective meta- and para-positions of the R¹², R¹³, R²², and R²³ phenyls can each independently be unsubstituted or be independently substituted with (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, or (C3-C10)cycloalkoxy(C1-C10)alkoxy;

R^{Y6} and Y₁₀ are independently (C1-C10)alkyl or (C1-C10)alkoxy, and R^{Y3}, R^{Y4}, R^{Y5}, R_{Y7}, R^{Y8}, and R^{Y9}, are independently H, (C1-C10)alkyl, or (C1-C10)alkoxy, provided that at least one of R^{Y3}, R^{Y4}, or R^{Y5}, and at least one of R^{Y7}, R^{Y8}, or R^{Y9}, is (C1-C10)alkyl or (C1-C10)alkoxy.

19. The method of any one of statements 1-10, wherein the ligand of formula (III) is of formula (V):

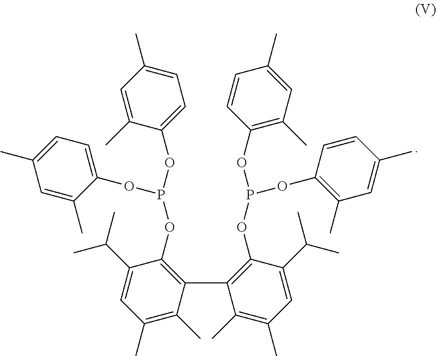

20. The method of any one of statements 1-19, wherein the one or more monodentate ligand of formula (IV) is each independently of formula (IVA)

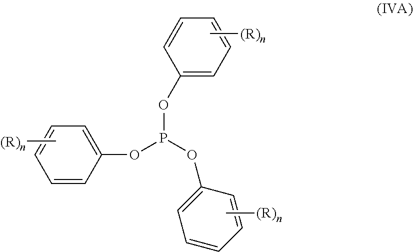

wherein each R is methyl and each n is independently 0, 1, or 2.
21. The method of any one of statements 1-19, wherein the monodentate ligand of formula (IV) is a ligand of formula (XIII):

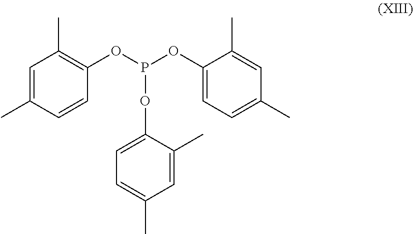

or a ligand of formula (XIV):

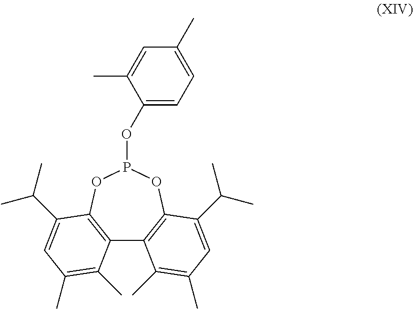 [SMILES: Cc1ccc(Op2oc3c(C(C)C)cc(C)c(C)c3c3c(C)c(C)cc(C(C)C)c3o2)c(C)c1]

or a mixture thereof.
22. The method of any one of statements 1-10, wherein the ligand blend comprises a mixture of a bidentate ligand of formula (V):

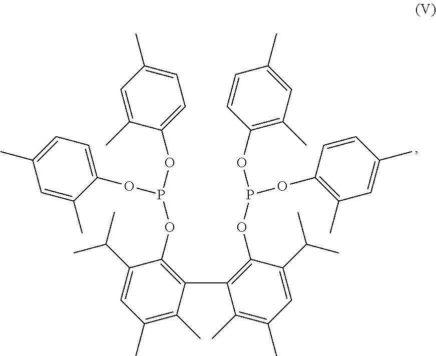

a monodentate ligand of formula (XIII):

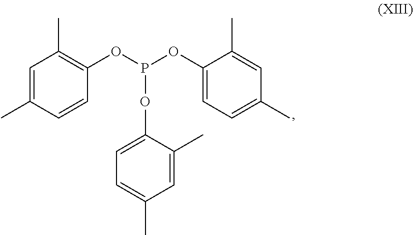

and, a monodentate ligand of formula (XIV):

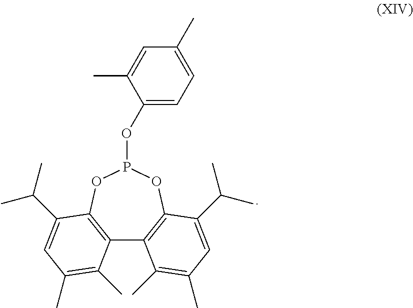 [SMILES: Cc1ccc(Op2oc3c(C(C)C)cc(C)c(C)c3c3c(C)c(C)cc(C(C)C)c3o2)c(C)c1]

23. The method of statement 22, wherein the liquid comprises cyclohexane, the liquid contains less than 100 ppm water, the liquid contains less than 50 ppm elemental oxygen, and the inner surface of the container comprises a polymer coating.
24. The method of any one of statements 22 or 23, wherein the container has an interior surface that does not leach a metal into the liquid to a concentration in excess of 100 ppm.
25. A stabilized composition comprising a phosphorus-based ligand or a ligand blend comprising a plurality of phosphorus-based ligands, the ligand or ligand blend being for formation of a metal-ligand complex for catalysis of a hydrocyanation reaction, wherein the ligand or ligand blend comprises one or more of:

a bidentate phosphorus-based ligand of formula (III)

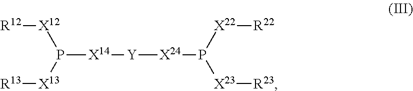

or,

a tridentate phosphorus-based ligand of formula (IIIA)

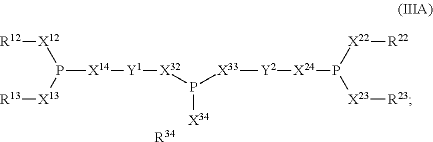

wherein for the ligand of formula (III), X¹², X¹³, X¹⁴, X²², X²³, and X²⁴, each independently is oxygen or a bond, provided that at least one of X¹², X¹³, X¹⁴, X²², X²³, or X²⁴ is oxygen, and for the ligand of formula (IIIA), X¹², X¹³, X¹⁴, X²², X²³, X²⁴, X³², X³³ and X³⁴, each independently is oxygen or a bond, provided that at least one of X¹², X¹³, X¹⁴, X²², X²³, X²⁴, X³², X³³, or X³⁴ is oxygen;

for the ligand of formula (III), R¹², R¹³, R²², and R²³, and for the ligand of formula (IIIA), R¹², R¹³, R²², R²³, and R³⁴, each independently is (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹², R¹³, R²², R²³, or R³⁴, each ring thereof is unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, one or more of pairs R¹² and R¹³ or R²² and R²³ are mutually directly bonded, such that the R¹²X¹² and R¹³X¹³ groups, or the R²²X²² and R²³X²³ groups, or both, together with the respective phosphorus atom to which each pair of groups is bonded, forms a respective ring;

for the ligand of formula (III) the group Y, and for the ligand of formula (IIIA), the groups Y¹ and Y² independently, is an (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl;

or, a monodentate phosphorus-based ligand of formula (IV)

P(X¹R¹)(X²R²)(X³R³) (IV)

wherein X¹, X² and X³ are each independently oxygen or a single bond, provided that at least one of X¹, X², or X³ is an oxygen; and R^{l}, R² and R³ is each independently (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹, R², or R³ each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, any two of R¹, R², or R³ are directly bonded to each other such that any pair of R¹X¹, R²X², and R³X³ groups, together with the phosphorus atom to which they are bonded, fauns a ring;
and, a liquid which partially or fully solubilizes the ligand or ligand blend, the liquid consisting essentially of one or more of:

(a) a solvent system that does not contain peroxidizable species; or,

(b) a solvent system that is substantially free of a dissolved metal.

26. The composition of statement 25, wherein the composition exhibits reduced ligand degradation relative to the ligand or ligand blend in a liquid under comparable conditions wherein the solvent system contains peroxidizable species or a dissolved metal, or both.
27. The composition of any one of statements 25-26, wherein the liquid in which the ligand or the ligand blend is partially or fully solubilized comprises a hydrocarbon, or comprises acetonitrile, or both.
28. The composition of statement 27, wherein the hydrocarbon is an aromatic hydrocarbon, a cyclic hydrocarbon, or a saturated hydrocarbon, or a mixture thereof.
29. The composition of any one of statements 25-28, wherein the liquid does not include an alkene, an ether, an acetal, a dioxane, an ethylene glycol ether, an acetate, a vinyl ether, or a secondary alcohol, or any mixture thereof.
30. The composition of any one of statements 25-29, wherein the liquid contains less than 100 ppm water.
31. The composition of any one of statements 25-30, wherein the liquid contains less than 50 ppm elemental oxygen.
32. The composition of any one of statements 25-31, wherein the liquid contains less than 100 ppm of a dissolved metal.
33. The composition of statement 32, wherein the liquid contains less than 100 ppm of dissolved nickel.
34. The composition of any one of statements 25-33, wherein for the ligand of formula (III) or formula (IIIA) or formula (IV), each respective R¹, R², R³, R¹², R¹³, R²², R²³ or R³⁴ is each an independently selected (C6-C20)aryl group, wherein each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl and (C6-C20)aryl(C1-C10)alkyl, or wherein any one or more pair of R¹ and R², or R¹² and R¹³, or R²² and R²³, is directly mutually bonded such that any mutually bonded pair, together with the respective X¹, X², X¹², X¹³, X²² or X²³ groups and the phosphorus atom to which they are bonded, forms a ring.
35. The composition of any one of statements 25-33, wherein each independently selected R¹, R², R³, R¹², R¹³, R²², R²³ or R³⁴ is a group of formula (II)

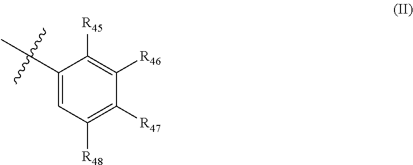

wherein a wavy line indicates a point of attachment; and wherein R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy.

36. The composition of any one of statements 25-34 wherein Y, or independently selected Y¹ or Y², is a (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl.
37. The composition of any one of statements 25-36, wherein the ligand of formula (III) is of formula (X):

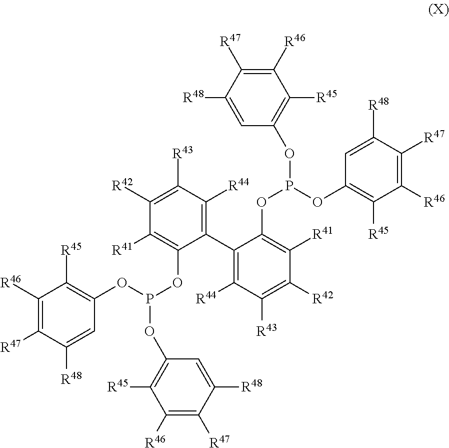

wherein each R⁴¹ and R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴², R⁴³, R⁴⁴, R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy.

38. The composition of statement 25, wherein for the ligand of formula (X),
R⁴¹ is methyl, ethyl, isopropyl, or cyclopentyl;
R⁴² is H or methyl;
R⁴³ is H or (C1-C4)alkyl;
R⁴⁴ is H or methyl;
R⁴⁵ is methyl, ethyl, or isopropyl; and
R⁴⁶, R⁴⁷ and R⁴⁸ are independently H or (C1-C4)alkyl.
39. The composition of any one of statements 25-33, wherein the ligand of formula (III) is of formula (VII):

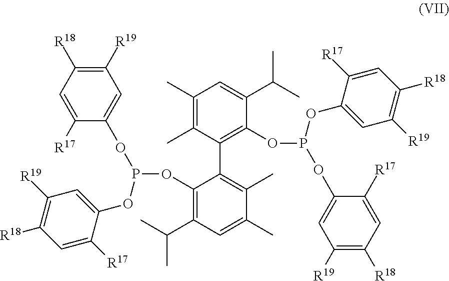

wherein R¹⁷ is methyl, ethyl, or iso-propyl, and R¹⁸ and R¹⁹ are independently H or methyl.
40. The composition of any one of statements 25-33, wherein the ligand of formula (III) is of formula (XII)

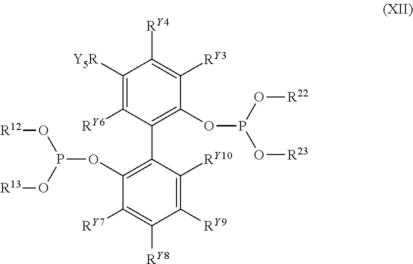

wherein R¹², R¹³, R²² and R²³ are each independently an unsubstituted or a substituted monovalent aryl, and each of R^{Y3}—R^{Y10} is independently selected from the group consisting of hydrogen, (C1-C10)alkyl, and (C1-C10)alkoxy, or wherein two adjacent R^{Y3}—R^{Y10} groups together form an optionally substituted fused aryl ring.
41. The composition of statement 40, wherein R¹², R¹³, R²², and R²³ are each independently phenyl substituted at a respective single ortho-position with a (C1-C10)alkyl or (C1-C10)alkoxy, wherein respective meta- and para-positions of the R¹², R¹³, R²², and R²³ phenyls can each independently be unsubstituted or be independently substituted with (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, or (C3-C10)cycloalkoxy(C1-C10)alkoxy;

R^{Y6} and R¹⁰ are independently (C1-C10)alkyl or (C1-C10)alkoxy, and R^{Y3}, R^{Y4}, R^{Y5}, R^{Y7}, R^{Y8}, and R^{Y9}, are independently H, (C1-C10)alkyl, or (C1-C10)alkoxy, provided that at least one of R^{Y3}, R^{Y4}, or R^{Y5}, and at least one of R^{Y7}, R^{Y8}, or R^{Y9}, is (C1-C10)alkyl or (C1-C10)alkoxy.

42. The composition of any one of statements 25-33, wherein the ligand of formula (III) is of formula (V):

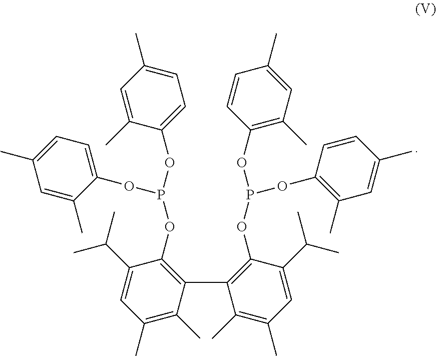

43. The composition of any one of statements 25-42, wherein the one or more monodentate ligand of formula (IV) is each independently of formula (IVA)

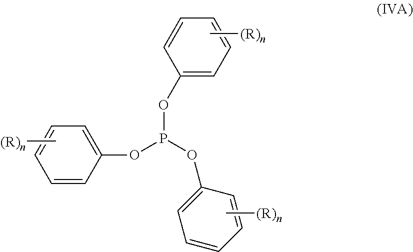

wherein each R is methyl and each n is independently 0, 1, or 2.
44. The composition of statement 25 wherein the monodentate ligand of formula (IV) is a ligand of formula (XIII):

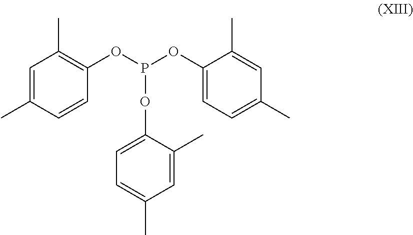

or a ligand of formula (XIV):

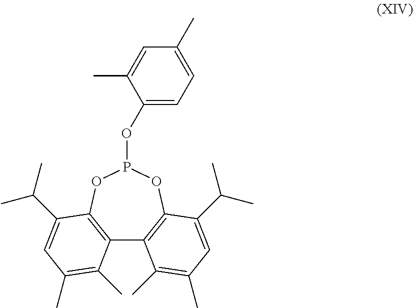 [SMILES: Cc1ccc(Op2oc3c(C(C)C)cc(C)c(C)c3c3c(C)c(C)cc(C(C)C)c3o2)c(C)c1]

or is a mixture thereof.
45. The composition of statement 25 wherein the ligand blend comprises a mixture of a bidentate ligand of formula (V):

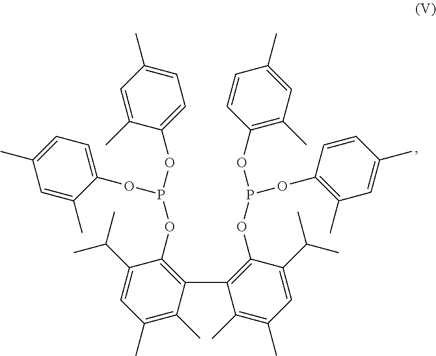

a monodentate ligand of formula (XIII):

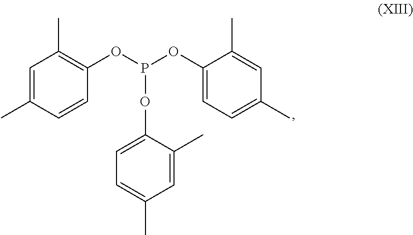

and, a monodentate ligand of formula (XIV):

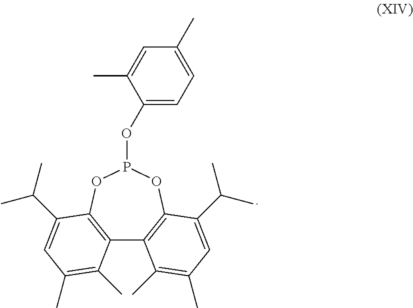 [SMILES: Cc1ccc(Op2oc3c(C(C)C)cc(C)c(C)c3c3c(C)c(C)cc(C(C)C)c3o2)c(C)c1]

46. The composition of statement 45 wherein the liquid comprises cyclohexane, the liquid contains less than 100 ppm water, and the liquid contains less than 50 ppm elemental oxygen.
47. The composition of any one of statements 25-46, contained in a storage container, the container having an inner surface in contact with the liquid that does not leach a metal into the liquid.
48. The composition of statement 47, wherein the inner surface of the container does not leach nickel into the liquid.
49. The composition of statement 25, wherein the vessel has an interior surface that does not leach a metal into the liquid to a concentration in excess of 100 ppm.
50. The composition of statement 47, wherein the inner surface of the container is coated with a polymer.

Accordingly, the foregoing aspects are set forth without any loss of generality to, and without imposing limitations upon any claimed invention. It is to be understood that this disclosure is not limited to particular aspects described, as such can vary. It is also to be understood that the telininology used herein is for the purpose of describing particular aspects only, and is not intended to be limiting, since the scope of the present disclosure will be limited only by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein. As will be apparent to those of skill in the art upon reading this disclosure, each of the individual aspects described and illustrated herein has discrete components and features that can be readily separated from or combined with the features of any of the other several examples without departing from the scope or spirit of the present disclosure. Any recited method can be carried out in the order of events recited or in any other order that is logically possible.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. Applicants reserve the right to physically incorporate into this specification any and all materials and information from any such cited patents or publications. The citation of any publication is for its disclosure prior to the filing date and should not be construed as an admission that the present disclosure is not entitled to antedate such publication by virtue of prior disclosure. Further, the dates of publication provided could be different from the actual publication dates that can need to be independently confirmed. All patents and publications referenced or mentioned herein are also indicative of the levels of skill of those skilled in the art to which the invention pertains.

1. A method of stabilizing a phosphorus-based ligand or a ligand blend comprising a plurality of phosphorus-based ligands, wherein the ligand or ligand blend used in the formation of a metal-ligand complex for catalysis of a hydrocyanation reaction comprises one or more of:
a bidentate phosphorus-based ligand of formula (III) 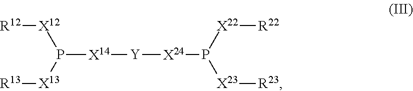
a tridentate phosphorus-based ligand of formula (IIIA) 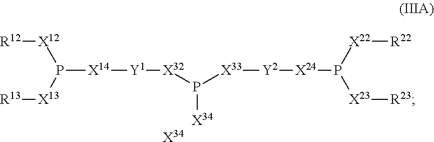
wherein for the ligand of formula (III), X¹², X¹³, X¹⁴, X²², X²³, and X²⁴, each independently is oxygen or a bond, provided that at least one of X¹², X¹³, X¹⁴, X²², X²³, or X²⁴ is oxygen, and for the ligand of formula (IIIA), X¹², X¹³, X¹⁴, X²², X²³, X²⁴, X³², X³³, and X³⁴, each independently is oxygen or a bond, provided that at least one of X¹², X¹³, X¹⁴, X²², X²³, X²⁴, X³², X³³, or X³⁴ is oxygen;
for the ligand of formula (III), R¹², R¹³, R²², and R²³, and for the ligand of formula (IIIA), R¹², R¹³, R²², R²³, and R³⁴, each independently is (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹², R¹³, R²², R²³, or R³⁴, each ring thereof is unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, one or more of pairs R¹² and R¹³ or R²² and R²³ are mutually directly bonded, such that the R¹²X¹² and R¹³X¹³ groups, or the R²²X²² and R²³X²³ groups, or both, together with the respective phosphorus atom to which each pair of groups is bonded, forms a respective ring;
for the ligand of formula (III) the group Y, and for the ligand of formula (MA), the groups Y¹ and Y² independently, is an (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl;
or, a monodentate phosphorus-based ligand of formula (IV)
P(X¹R¹)(X²R²)(X³R³) (IV)
wherein X¹, X² and X³ are each independently oxygen or a single bond, provided that at least one of X¹, X², or X³ is an oxygen; and R¹, R² and R³ is each independently (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹, R², or R³ each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, any two of R¹, R², or R³ are directly bonded to each other such that any pair of R¹X¹, R²X², and R³X³ groups, together with the phosphorus atom to which they are bonded, forms a ring;
the method comprising forming a mixture of the ligand or the ligand blend with a liquid which partially or fully solubilizes the ligand or ligand blend, the liquid consisting essentially of one or more of:
(a) a solvent system that does not contain peroxidizable species; or,
(b) a solvent system that is substantially free of a dissolved metal;
wherein the method provides a storage stable mixture of the ligand or ligand blend; and wherein the method further comprises utilizing a container to contain the mixture of the ligand or ligand blend and the liquid, the container optionally having an inner surface in contact with the liquid that does not leach a metal into the liquid.

2. The method of claim 1, wherein the liquid in which the ligand or the ligand blend is partially or fully solubilized comprises a hydrocarbon, or comprises acetonitrile, or both.

3. The method of claim 2, wherein the hydrocarbon is an aromatic hydrocarbon, a cyclic hydrocarbon or a saturated hydrocarbon, or a mixture thereof.

4. The method of claim 1, wherein the liquid does not include an alkene, an ether, an acetal, a dioxane, an ethylene glycol ether, an acetate, a vinyl ether, or a secondary alcohol, or any mixture thereof.

5. The method of claim 1, wherein the container inner surface in contact with the liquid does not leach a metal into the liquid.

6. The method of claim 1, wherein the liquid contains less than 100 ppm water.

7. The method of claim 1, wherein the liquid contains less than 50 ppm elemental oxygen.

8. The method of claim 1, wherein the liquid is substantially free of a dissolved metal.

9. The method of claim 8, wherein the liquid is substantially free of dissolved nickel.

10. The method of claim 1, further comprising the step of monitoring an amount of peroxides in the liquid after forming the mixture of the ligand or ligand blend and the liquid.

11. The method of claim 1, wherein for the ligand of formula (III) or formula (IIIA) or formula (IV), each respective R¹, R², R³, R¹², R¹³, R²², R²³ or R³⁴ is each an independently selected (C6-C20)aryl group, wherein each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl and (C6-C20)aryl(C1-C10)alkyl, or wherein any one or more pair of R¹ and R², or R¹² and R¹³, or R²² and R²³, is directly mutually bonded such that any mutually bonded pair, together with the respective X¹, X², X¹², X¹³, X²² or X²³ groups and the phosphorus atom to which they are bonded, forms a ring.

12. The method of claim 1, wherein each independently selected R¹, R², R³, R¹², R¹³, R²², R²³ or R³⁴ is a group of formula (II) 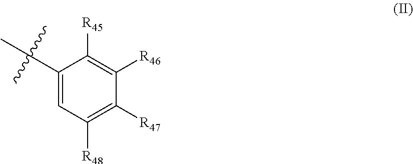
wherein a wavy line indicates a point of attachment; and wherein R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy.

13. The method of claim 1, wherein Y, or independently selected Y¹ or Y², is a (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl.

14. The method of claim 1, wherein the ligand of formula (III) is of formula (X): 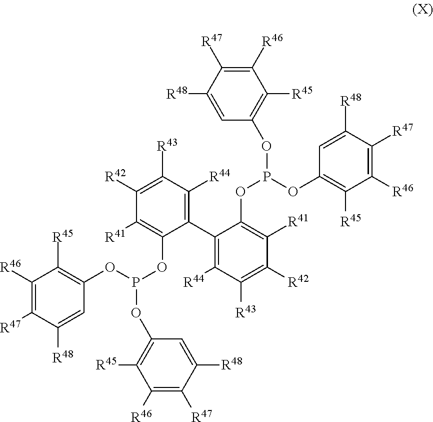
wherein each R⁴¹ and R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴², R⁴³, R⁴⁴, R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy.

15. The method of claim 14, wherein for the ligand of formula (X),
R⁴¹ is methyl, ethyl, isopropyl or cyclopentyl;
R⁴² is H or methyl;
R⁴³ is H or (C1-C4)alkyl;
R⁴⁴ is H or methyl;
R⁴⁵ is methyl, ethyl, or isopropyl; and
R⁴⁶, R⁴⁷ and R⁴⁸ are independently H or (C1-C4)alkyl.

16. The method of claim 1, wherein the ligand of formula (III) is of formula (VII): 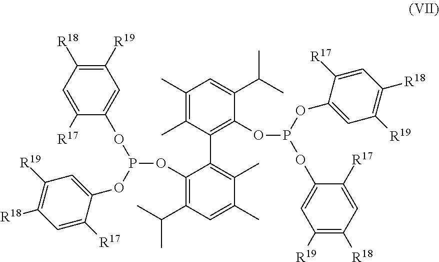
wherein R¹⁷ is methyl, ethyl or isopropyl, and R¹⁸ and R¹⁹ are independently H or methyl.

17. The method of claim 1, wherein the ligand of formula (III) is of formula (XII) 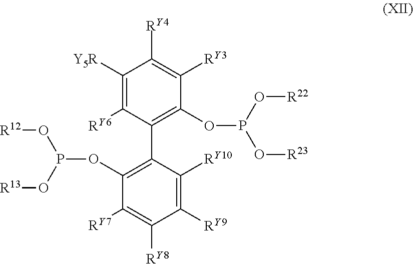
wherein R¹², R¹³, R²² and R²³ are each independently an unsubstituted or a substituted monovalent aryl, and each of R^{Y3}—R^{Y10} is independently selected from the group consisting of hydrogen, (C1-C10)alkyl, and (C1-C10)alkoxy, or wherein two adjacent R^{Y3}—R^{Y10} groups together form an optionally substituted fused aryl ring.

18. The method of claim 17, wherein R¹², R¹³, R²², and R²³ are each independently phenyl substituted at a respective single ortho-position with a (C1-C10)alkyl or (C1-C10)alkoxy, wherein respective meta- and para-positions of the R¹², R¹³, R²², and R²³ phenyls can each independently be unsubstituted or be independently substituted with (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, or (C3-C10)cycloalkoxy(C1-C10)alkoxy;
R^{Y6} and R^{Y10} are independently (C1-C10)alkyl or (C1-C10)alkoxy, and R^{Y3}, R^{Y4}, R^{Y5}, R^{Y7}, R^{Y8}, and R^{Y9}, are independently H, (C1-C10)alkyl, or (C1-C10)alkoxy, provided that at least one of R^{Y3}, R^{Y4}, or R^{Y5}, and at least one of R^{Y7}, R^{Y8}, or R^{Y9}, is (C1-C10)alkyl or (C1-C10)alkoxy.

19. The method of claim 1, wherein the ligand of formula (III) is of formula (V):

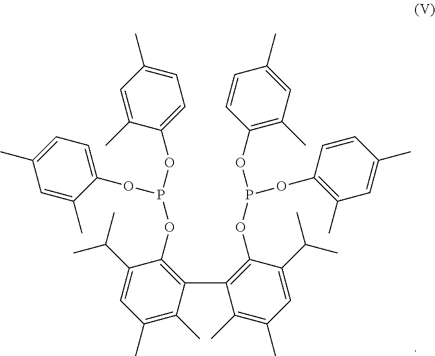

20. The method of claim 1, wherein the one or more monodentate ligand of formula (IV) is each independently of formula (IVA) 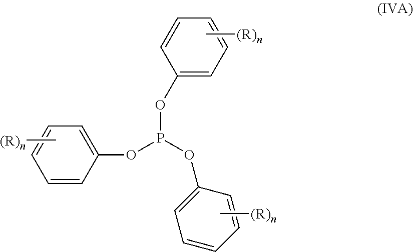
wherein each R is methyl and each n is independently 0, 1, or 2.

21. The method of claim 1, wherein the monodentate ligand of formula (IV) is a ligand of formula (XIII): 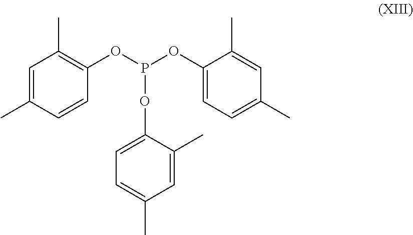
or a ligand of formula (XIV): 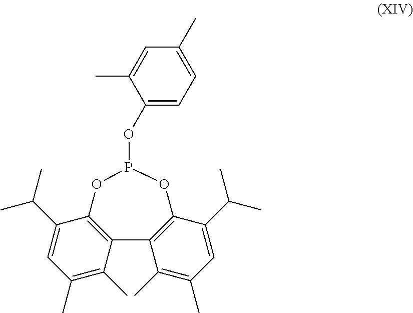 [SMILES: Cc1ccc(Op2oc3c(C(C)C)cc(C)c(C)c3c3c(C)c(C)cc(C(C)C)c3o2)c(C)c1]
or is a mixture thereof.

22. The method of claim 1, wherein the ligand blend comprises a mixture of a bidentate ligand of formula (V): 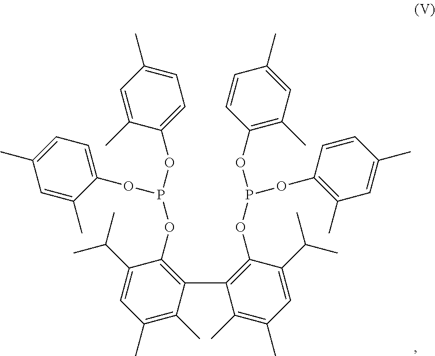
a monodentate ligand of formula (XIII): 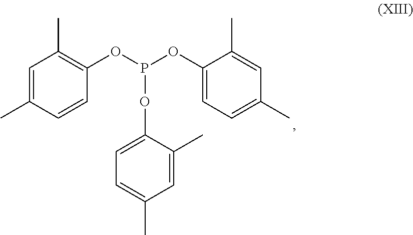
and, a monodentate ligand of formula (XIV):

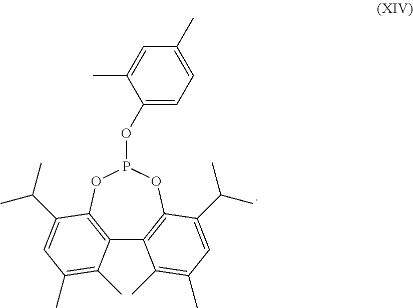 [SMILES: Cc1ccc(Op2oc3c(C(C)C)cc(C)c(C)c3c3c(C)c(C)cc(C(C)C)c3o2)c(C)c1]

23. The method of claim 22, wherein the liquid comprises cyclohexane, the liquid contains less than 100 ppm water, the liquid contains less than 50 ppm elemental oxygen, and the inner surface of the container comprises a polymer coating, whereby the coating substantially prevents leaching of metal into the liquid.

24. The method of claim 22, wherein the container has an interior surface that does not leach a metal into the liquid to a concentration in excess of 100 ppm.

25. A stabilized composition comprising a phosphorus-based ligand or a ligand blend comprising a plurality of phosphorus-based ligands, the ligand or ligand blend being for formation of a metal-ligand complex for catalysis of a hydrocyanation reaction, wherein the ligand or ligand blend comprises one or more of:
a bidentate phosphorus-based ligand of formula (III) 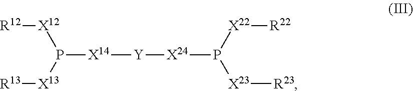
or a tridentate phosphorus-based ligand of formula (IIIA) 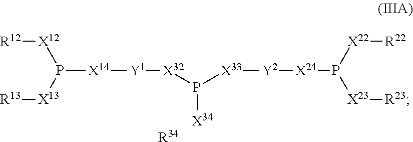
wherein for the ligand of formula (III), X¹², X¹³, X¹⁴, X²², X²³, and X²⁴, each independently is oxygen or a bond, provided that at least one of X¹², X¹³, X¹⁴, X²², X²³, or X²⁴ is oxygen, and for the ligand of formula (IIIA), X¹², X¹³, X¹⁴, X²², X²³, X²⁴, X³², X³³, and X³⁴, each independently is oxygen or a bond, provided that at least one of X¹², X¹³, X¹⁴, X²², X²³, X²⁴, X³², X³³, or X³⁴ is oxygen;
for the ligand of formula (III), R¹², R¹³, R²², and R²³, and for the ligand of formula (IIIA), R¹², R¹³, R²², R²³, and R³⁴, each independently is (C1-C10)alkyl, (C3-C10)cycloalkyl, (C3-C10)cycloakyl(C1-C10)alkyl, (C6-C20)aryl, or (C6-C20)aryl(C1-C10)alkyl, wherein any (C6-C20)aryl or (C6-C20)aryl(C1-C10)alkyl of R¹², R¹³, R²², R²³, or R³⁴, is unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, one or more of pairs R¹² and R¹³ or R²² and R²³ are mutually directly bonded, such that the R¹²X¹² and R¹³X¹³ groups, or the R²²X²² and R²³X²³ groups, or both, together with the respective phosphorus atom to which each pair of groups is bonded, forms a respective ring;
for the ligand of formula (III) the group Y, and for the ligand of formula (IIIA), the groups Y¹ and Y² independently, is an (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl;
or a monodentate phosphorus-based ligand of formula (IV)
P(X¹R¹)(X²R²)(X³R³) (IV)
wherein X¹, X² and X³ are each independently oxygen or a single bond, provided that at least one of X¹, X², or X³ is an oxygen; and R¹, R² and R³ is each independently (C1-C10)alkyl, (C3-C10)cycloalkyl, (C3-C10)cycloalkyl(C1-C10)alkyl, (C6-C20)aryl, or (C6-C20)aryl(C1-C10)alkyl, wherein for any (C6-C20)aryl or (C6-C20)aryl(C1-C10)alkyl of R¹, R², or R³ each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, and (C6-C20)aryl(C1-C10)alkyl; or, any two of R¹, R², or R³ are directly bonded to each other such that any pair of R¹X¹, R²X², and R³X³ groups, together with the phosphorus atom to which they are bonded, forms a ring;
and, a liquid which partially or fully solubilizes the ligand or ligand blend, the liquid consisting essentially of one or more of:
(a) a solvent system that does not contain peroxidizable species; or,
(b) a solvent system that is substantially free of a dissolved metal,
wherein the composition is storage stable.

26. The composition of claim 25, wherein the composition exhibits reduced ligand degradation relative to the ligand or ligand blend in a liquid under comparable conditions wherein the solvent system contains peroxidizable species or a dissolved metal, or both.

27. The composition of claim 25, wherein the liquid in which the ligand or the ligand blend is partially or fully solubilized comprises a hydrocarbon, or comprises acetonitrile, or both.

28. The composition of claim 27, wherein the hydrocarbon is an aromatic hydrocarbon, a cyclic hydrocarbon, or a saturated hydrocarbon, or a mixture thereof.

29. The composition of claim 25, wherein the liquid does not include an alkene, an ether, an acetal, a dioxane, an ethylene glycol ether, an acetate, a vinyl ether, or a secondary alcohol, or any mixture thereof.

30. The composition of claim 25, wherein the liquid contains less than 100 ppm water.

31. The composition of claim 25, wherein the liquid contains less than 50 ppm elemental oxygen.

32. The composition of claim 25, wherein the liquid contains less than 100 ppm of a dissolved metal.

33. The composition of claim 32, wherein the liquid contains less than 100 ppm of dissolved nickel.

34. The composition of claim 25, wherein for the ligand of formula (III) or formula (IIIA) or formula (IV), each respective R¹, R², R³, R¹², R¹³, R²², R²³ or R³⁴ is each an independently selected (C6-C20)aryl group, wherein each ring thereof is independently unsubstituted or is substituted with 1-4 substituents independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl and (C6-C20)aryl(C1-C10)alkyl, or wherein any one or more pair of R¹ and R², or R¹² and R¹³, or R²² and R²³, is directly mutually bonded such that any mutually bonded pair, together with the respective X¹, X², X¹², X¹³, X²² or X²³ groups and the phosphorus atom to which they are bonded, forms a ring.

35. The composition of claim 25, wherein each independently selected R¹, R², R³, R¹², R¹³, R²², R²³ or R³⁴ is a group of formula (II) 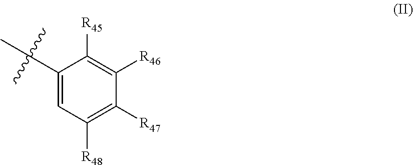
wherein a wavy line indicates a point of attachment; and wherein R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy.

36. The composition of claim 25 wherein Y, or independently selected Y¹ or Y², is a (C6-C20)arylene group, wherein each ring thereof is independently unsubstituted or is substituted with 1-4 (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, (C3-C10)cycloalkoxy(C1-C10)alkoxy, (C6-C20)aryl, (C6-C20)aryl(C1-C10)alkyl, fluorine, chlorine, bromine, or (C1-C10)haloalkyl.

37. The composition of claim 25, wherein the ligand of formula (III) is of formula (X): 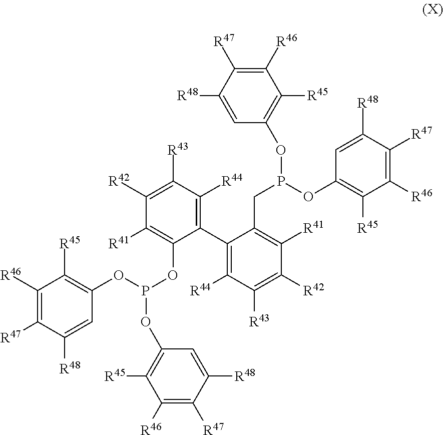
wherein each R⁴¹ and R⁴⁵ is independently selected from the group consisting of (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy, and each of R⁴², R⁴³, R⁴⁴, R⁴⁶, R⁴⁷ and R⁴⁸ is independently selected from the group consisting of H, (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, and (C3-C10)cycloalkoxy(C1-C10)alkoxy.

38. The composition of claim 25, wherein for the ligand of formula (X),
R⁴¹ is methyl, ethyl, isopropyl, or cyclopentyl;
R⁴² is H or methyl;
R⁴³ is H or (C1-C4)alkyl;
R⁴⁴ is H or methyl;
R⁴⁵ is methyl, ethyl, or isopropyl; and
R⁴⁶, R⁴⁷ and R⁴⁸ are independently H or (C1-C4)alkyl.

39. The composition of claim 25, wherein the ligand of formula (III) is of formula (VII): 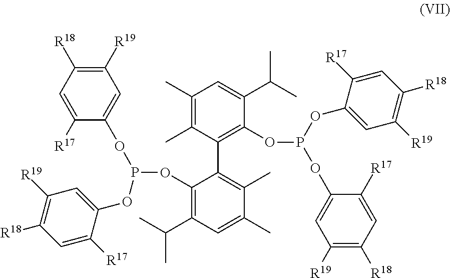
wherein R¹⁷ is methyl, ethyl, or iso-propyl, and R¹⁶ and R¹⁹ are independently H or methyl.

40. The composition of claim 25, wherein the ligand of formula (III) is of formula (XII) 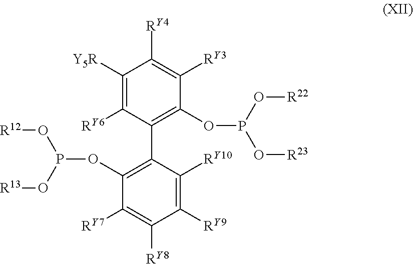
wherein R¹², R¹³, R²² and R²³ are each independently an unsubstituted or a substituted monovalent aryl, and each of R^{Y3}—R^{Y10} is independently selected from the group consisting of hydrogen, (C1-C10)alkyl, and (C1-C10)alkoxy, or wherein two adjacent R^{Y3}—R^{Y10} groups together form an optionally substituted fused aryl ring.

41. The composition of claim 40, wherein R¹², R¹³, R²², and R²³ are each independently phenyl substituted at a respective single ortho-position with a (C1-C10)alkyl or (C1-C10)alkoxy, wherein respective meta- and para-positions of the R¹², R¹³, R²², and R²³ phenyls can each independently be unsubstituted or be independently substituted with (C1-C10)alkyl, (C3-C10)cycloalkyl, (C1-C10)alkoxy, (C3-C10)cycloalkoxy, (C3-C10)cycloalkyl(C1-C10)alkyl, (C3-C10)cycloalkoxy(C1-C10)alkyl, (C3-C10)cycloalkyl(C1-C10)alkoxy, or (C3-C10)cycloalkoxy(C1-C10)alkoxy;
R^{Y6} and R^{Y10} are independently (C1-C10)alkyl or (C1-C10)alkoxy, and R^{Y3}, R^{Y4}, R^{Y5}, R^{Y7}, R^{Y8}, and R⁹, are independently H, (C1-C10)alkyl, or (C1-C10)alkoxy, provided that at least one of R^{Y3}, R^{Y4}, or R^{Y5}, and at least one of R^{Y7}, R^{Y8}, or R^{Y9}, is (C1-C10)alkyl or (C1-C10)alkoxy.

42. The composition of claim 25, wherein the ligand of formula (III) is of formula (V):

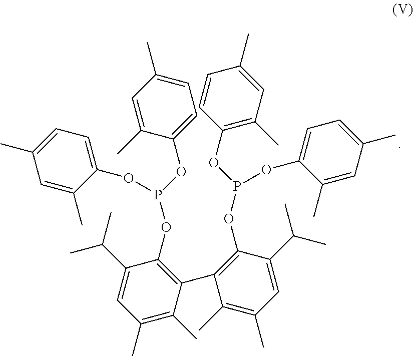

43. The composition of claim 25, wherein the one or more monodentate ligand of formula (IV) is each independently of formula (IVA) 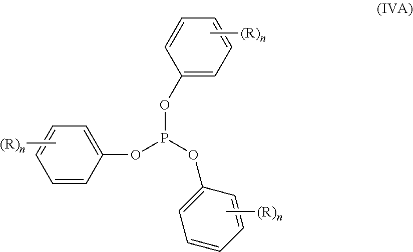
wherein each R is methyl, and each n is independently 0, 1, or 2.

44. The composition of claim 25 wherein the monodentate ligand of formula (IV) is a ligand of formula (XIII): 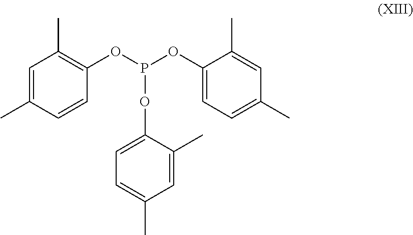
or a ligand of formula (XIV): 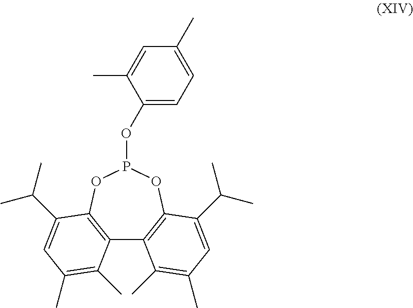 [SMILES: Cc1ccc(Op2oc3c(C(C)C)cc(C)c(C)c3c3c(C)c(C)cc(C(C)C)c3o2)c(C)c1]
or a mixture thereof.

45. The composition of claim 25 wherein the ligand blend comprises a mixture of a bidentate ligand of formula (V): 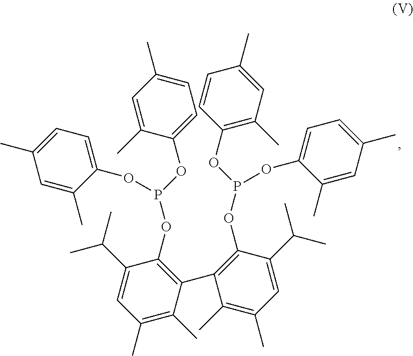
a monodentate ligand of formula (XIII): 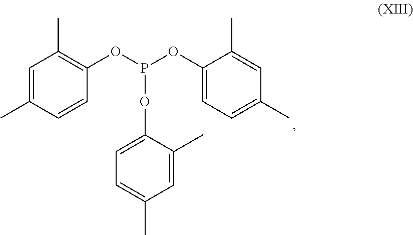
and, a monodentate ligand of formula (XIV):

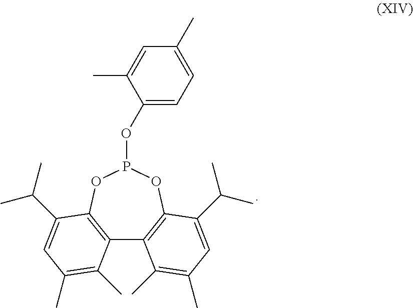 [SMILES: Cc1ccc(Op2oc3c(C(C)C)cc(C)c(C)c3c3c(C)c(C)cc(C(C)C)c3o2)c(C)c1]

46. The composition of claim 45 wherein the liquid comprises cyclohexane, the liquid contains less than 100 ppm water, and the liquid contains less than 50 ppm elemental oxygen.

47. The composition of claim 25, contained in a storage container, the container having an inner surface in contact with the liquid that does not leach a metal into the liquid.

48. The composition of claim 47, wherein the inner surface of the container does not leach nickel into the liquid.

49. The composition of claim 25, wherein the vessel has an interior surface that does not leach a metal into the liquid to a concentration in excess of 100 ppm.

50. The composition of claim 47, wherein the inner surface of the container is coated with a polymer, whereby the coating substantially prevents leaching of metal into the liquid.
